(19) United States
(12) Patent Application Publication
(10) Pub. No.: US 2026/0102971 A1
(43) Pub. Date: Apr. 16, 2026

(54) SYSTEM AND METHOD FOR HIGH-THROUGHPUT ADAPTIVE ADDITIVE MANUFACTURING

(71) Applicant: Advanced Printed Electronic Solutions LLC, Fishkill, NY (US)

(72) Inventor: Richard Neill, Garrison, NY (US)

(21) Appl. No.: 19/355,538

(22) Filed: Oct. 10, 2025

Related U.S. Application Data
(60) Provisional application No. 63/705,855, filed on Oct. 10, 2024.
(60) Provisional application No. 63/783,592, filed on Apr. 4, 2025.

(51) Int. Cl. B29C 64/245; B29C 64/236; B29C 64/241; B33Y 10/00; B33Y 30/00

(52) U.S. Cl. CPC B29C 64/245; B29C 64/236; B29C 64/241; B33Y 10/00; B33Y 30/00

(57) ABSTRACT

A system for additive manufacturing is provided. The additive manufacturing system includes a build platform movably coupled to a motion platform. The build platform being movable in at least a X direction and a Y direction relative to the motion platform. The system further includes a tool station suspended over the motion platform, the tool station includes one or more tools coupled thereto and the one or more tools being movable in at least tone direction relative to the motion platform. The build platform is movable over the motion platform under the tool station.

### CROSS-REFERENCE TO RELATED APPLICATIONS

The present application claims priority to U.S. Provisional Patent Application No. 63/783,592, filed Apr. 4, 2025, and titled “SYSTEM AND METHOD FOR HIGH-THROUGHPUT ADAPTIVE ADDITIVE MANUFACTURING”, and to U.S. Provisional Patent Application No. 63/705,855, filed Oct. 10, 2024, and titled “SYSTEM AND METHOD FOR HIGH-THROUGHPUT ADDITIVE MANUFACTURING”, the contents of which are hereby incorporated by reference in their entirety.

### BACKGROUND

3D printing is widely used for prototyping and small batch manufacturing projects. The versatility and utility of one device being able to manufacture a variety of designs without needing to switch out substantial tooling. However, these benefits are often met with increased costs and throughput limitation. Accordingly, Current 3D printing system designs for additive manufacturing (AM) and additive manufactured electronics (AME, also known as 3D printed electronics) are suitable for research and development. However due to the limited throughput and cost concerns, such systems remain unsuitable for full scale volume manufacturing projects or mass-customization applications.

Additionally, traditional 3D printing systems focus on manufacturing in series as opposed to in parallel which in turn limits the throughput the 3D printing system can achieve. This is particularly true in AM and AME situations when the object being printed requires additional processing before, after, or during the manufacturing process. Finally, traditional AM systems are not easily reconfigurable, modular, or adaptive, for different applications, tools and their associated processing tasks based on the type of manufacturing project required. This further limits conventional AM system adoption within commercial and industrial manufacturing applications as conventional AM systems lack flexibility or reconfigurability, or ability to execute different software processes in response to changing manufacturing requirements, real-time sensor data and/or feedback from manufacturing processes.

These factors, among others, have contributed towards the lack of widespread adoption utilizing AM and AME systems and processes for product realization, industrial applications, electronic applications, photonic or optical applications, and manufacturing, including printed circuit boards (PCBs), microsystems, and semiconductor device packaging.

### SUMMARY

According to some embodiments of the present disclosure, a system for additive manufacturing is provided. The additive manufacturing system includes a build platform movably coupled to a motion platform. The build platform is movable in at least a X direction and a Y direction relative to the motion platform. The system further includes a tool station suspended adjacent the motion platform, wherein the tool station includes one or more tools coupled thereto, the one or more tools being movable in at least one direction relative to the motion platform. The build platform is movable relative to the motion platform under the tool station.

### BRIEF DESCRIPTION OF DRAWINGS

The subject matter, which is regarded as the disclosure, is particularly pointed out in the specification. The foregoing and other features, and advantages of the disclosure are apparent from the following detailed description taken in conjunction with the accompanying drawings in which like reference numerals refer to like elements throughout the different views:

FIG. 1 is a perspective view of the high throughput adaptive additive manufacturing system having tool station axes with three degrees of freedom, each having tool clusters;

FIGS. 2A-2B are schematic views of tool cluster, tool holder, and tool station configurations;

FIG. 3 is a perspective view of an arrangement of tool clusters mounted on tool station axes;

FIGS. 4A-4B are perspective views of a build platform and a motion platform in a linear configuration;

FIGS. 5A-5B are perspective views of a build platform and a motion platform in a two-dimensional matrix configuration;

FIGS. 6A-6B are perspective views of one or more build platforms and a motion platform in a matrix configuration;

FIG. 7 is a perspective view of an additive manufacturing system in an N×M matrix motion platform and tool stations configuration;

FIGS. 8A-8C are top down view of various motion platform configurations;

FIG. 9A is a schematic view of an exemplary additive manufacturing system in a 3×M matrix arrangement with N available build platforms arrangement;

FIG. 9B is a logical architecture of the exemplary additive manufacturing system;

FIG. 9C illustrates a state transition diagram for generalized additive manufactured electronic applications;

FIG. 9D is a schematic drawing of an adaptive additive manufacturing layout;

FIGS. 10A-10B are schematic and a perspective views of an example 4×1 additive manufacturing system for additive manufacturing electronic applications;

FIGS. 11A-11B are schematic and a perspective views of an example 4×1 additive manufacturing system for semiconductor chip package fabrication applications;

FIG. 12A is flow chart of an exemplary process for semiconductor chip fabrication;

FIG. 12B is a flow chart of an exemplary process for semiconductor chip fabrication;

FIGS. 12C-12E are schematic views of an exemplary 2.5D digital patterning process, according to FIG. 12B;

FIGS. 13A-13B are schematic and perspective views of an example 2×1 volumetric additive manufacturing substrate-only applications;

FIGS. 14A-14B are schematic and perspective views of an example minimal 2×1 platform for volumetric additive manufacturing-based additive manufacturing electronics;

FIGS. 15A-15B are schematic and perspective views of an example optimized 2-stage pipeline for volumetric additive manufacturing-based additive manufacturing electronics with multi-material synthesis;

FIG. 16 is a flow chart showing a process for optimized 2×1 platform for volumetric additive manufacturing-based additive manufacturing electronics with multi-material synthesis;

FIGS. 17-25C are schematic views of various adaptive additive manufacturing system layout;

FIG. 26 is a perspective view of an additive manufacturing system including an H-shaped truss structural component;

FIGS. 27-31 are perspective view of configurations of an adaptive additive manufacturing system; and

FIG. 32 illustrates stacking adaptive additive manufacturing systems vertically to level N.

### DETAILED DESCRIPTION

While the subject matter disclosed herein is discussed primarily in terms of AM applications, it is appreciated that the teachings of the present disclosure are applicable for use with various types of manufacturing process, for example, additive manufactured electronics or AME, volumetric additive manufacturing (VAM), 3D printed electronics, semiconductor packaging, assembly and test digital lithographic methods, binder jetting, material extrusion, powder bed fusion, vat polymerization, direct energy deposition, material jetting, and sheet lamination, although not limited thereto.

The subject matter disclosed herein relates to a system and method an additive manufacturing platform implementation for high-throughput, adaptive AM and AME. The system and method is also suitable for mass customization, and AM and AME-based semiconductor packaging manufacturing. In one embodiment the system implementation comprises a single X-axis (Xp) and Y-axis (Yp) motion platform with movably coupled build platform and one or more X, Y, and/or Z axis, and combinations thereof, overhead tool stations that can be organized in a pipeline to extend the throughput and/or functionality of the system. One or more X, Y, and/or Z axis, and combinations thereof, tool station can contain one or more tools as illustrated. Tools may include VAM multi-material substrate fabrication, deposition of multiple materials based on jetting, ink-jetting, valve-jetting, aerosol, direct-write printing, electrohydrodynamic (EHD) printing, inkjet, dispensing, including conductive, insulating, adhesives, and other materials, curing, cleaning and post-processing tools, camera, vision, optical digital patterning, and calibration tools, and a variety of pick-and-place and other related tools for electronics and semiconductor chip and package manufacturing.

In an embodiment, there are multiple XYZ tool stations or “tool stations” arranged in different configurations, including, but not limited to, a linear and 2-dimensional array/matrix topologies, a non-linear and 2-dimensional arrangement, and a partially linear and partially non-linear and 2-dimensional arrangement, wherein each tool station element contains an independent set of tool types, referred to as a tool cluster, wherein each tool cluster is coupled to a tool holder that is actuated in XYZ dimensions. The tool holder may be on any side the motion platform actuates. E.g. any of the 4 sides in the case of an XYZ squared shaped tool motion platform.

In an embodiment, the build platform may support any combination of a conventional build platforms, mobile build platforms, dynamic VAT, or multi-dimensional build platforms in either passive or active configurations.

In other embodiments, the rectangle X-axis motion platform (where the build platform resides on) moves in Xp is replaced with a circular 2-axis, A and B pitch and rotational motion platform. As before, multiple overhead tool stations in YZ-axes, XY, XZ, and XYZ-axes or combinations thereof may be realized and are possible with no loss of generality.

In another embodiment, a build platform instance may be attached in several ways, including but not limited to, 1) fixed to a motion platform that may move in one or more of the X, Y, or Z dimensions, and/or 2) coupled by various methods such as mechanical or magnetic attachment to a magnetically levitated motion platform called a “shuttle”, where each build platform instance is coupled to a movable shuttle or carrier, that is able to reposition itself anywhere on the surface of the motion platform. In an embodiment, the build platform may be configured in the manner described in U.S. Provisional Application Ser. No. 63/878453 filed Sep. 9, 2025 entitled “System and Method for Coupling, Decoupling and Storing Manufacturing Platforms”, the contents of which is incorporated be reference herein.

In another embodiment, the magnetically levitated shuttle in conjunction with its magnetic motion platform provides rotational, Z and pitch movements.

In another embodiment, the high-throughput AM system comprises multiple shuttles and coupled build platforms (or container/substrate vat) to reduce the fabrication time or increase the number of manufactured devices.

The arrangement of tools may be selected for the required manufacturing process. In an embodiment, the tool arrangement is optimized for one or more AME application domains in either of fully additive or conformal geometries, in the implementation of: electronic assemblies, sensors, antennas, semiconductor packaging, chiplet and heterogeneous integration of multiple dies for microsystems implementations (SiP, SoP), electronic connectors, and medical devices. It should be appreciated that the arrangements shown are non-limiting, and other arrangements are possible with no loss of generality.

In an embodiment, one or more of the tool stations can incorporate a volumetric additive manufacturing (VAM) tool station for accelerated substrate fabrication or the patterning and fabrication of multi-material interconnection networks comprising insulating or conductive structures. Additional tool station or stages may incorporate a VAM curing tool process and substrate cleaning or post-processing tool to prepare one or more substrates for further functionalization. In an embodiment additional tool stations may functionalize the one or more substrates with conductive and/or dielectric material depositions and dispensing of adhesives and conductive bonding materials by tools. In an embodiment the additional tool station or stations may include pick and place tools for attaching electronic components and chip dies to the one or more substrates to fabricate complex electronic assemblies and chip packaging applications.

In an embodiment, the build platforms may include one or more systems for dynamic substrate location and/or multi-dimensional build platforms to actuate complex substrate processing across the one or more tools, or tools located on the one more or YZ-axes, XZ-axes, XY-axes, or XYZ-axes overhead tool station.

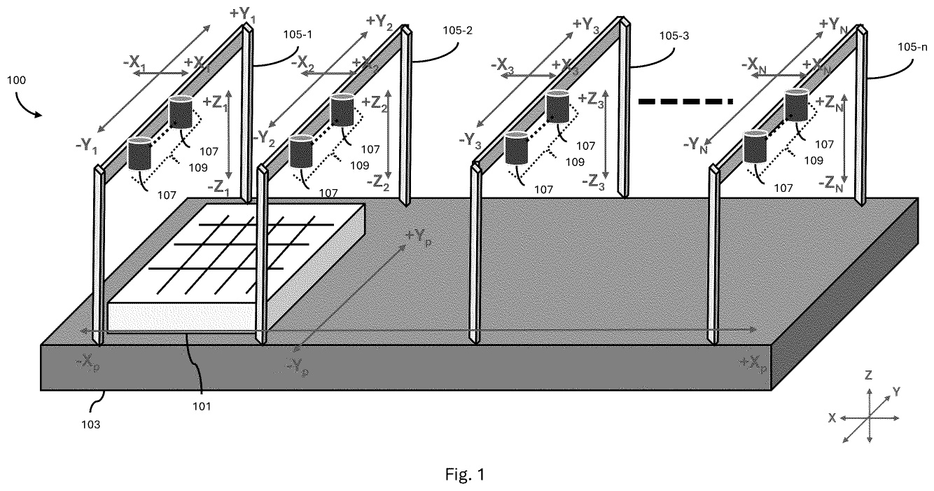

Referring now to FIG. 1, shown is a high-throughput, adaptive AM system 100 according to some embodiments of the present disclosure. The AM system 100 includes a build platform 101 movably coupled to the motion platform 103. In some embodiments, the AM system 100 includes a plurality of build platforms 101 movably coupled to the motion platform 103. As described herein, reference to “a build platform 101” or “the build platform 101” refers to “a build platform 101 of a plurality of build platforms 101” or “the build platform 101 of the plurality of build platforms 101”, unless expressly stated otherwise. The build platform 101 may be a conventional build platform such as a PEI-based surface, dynamic VAT with dynamic substrate position control, a multi-dimensional build-platform, a mobile build platform, combinations thereof, or another build platform used in AM applications. In some embodiments, the build platform 101 may be added to and/or removed from the motion platform 103. For example, the build platform 101 may be dynamically added or dynamically removed from the motion platform 103. The build platform 101 may be passive or active, or combinations thereof. The build platform 101 functions as the area or volume on or in which a target 3D object will be manufactured. In some embodiments, the build platform 101 maybe a flat surface, have one or more features or surfaces to be printed on, or may be a volumetric space to be printed in, for example printing objects suspending in a substrate, although not limited thereto. In some embodiments, a first build platform 101 may be coupled to a second build platform 101 to create a larger build platform 101 in the X, Y, and/or Z direction, and combinations thereof. The larger build platform may be greater in size than the first build platform and/or the second build platform. It should be understood, however, that additional build platforms 101 may be coupled together to create a larger build platform 101 in the X, Y, and/or Z direction, and combinations thereof.

The motion platform 103 may be a fixed motion platform or magnetic motion platform. The build platform 101 may be movably coupled to the motion platform 103 by mechanical means, magnets, electro magnets, or other couplings which allows the motion platform 103 to move the build platform 101 in the Xp or Yp directions. In some embodiments, the motion platform 103 may use a magnetic levitation (maglev) device, for example the ACOPOS 6D by B&R or other OEM providers based on the Flyways/Xbots solutions from Planar Motor Company, to move the build platform 101. In some embodiments, individual shuttles may be coupled to the build platform 101 to move the build platform 101 over the motion platform 103 in a similar manner to pallet shuttles used in warehouses. In some embodiments, the build platform 101 may further movable in the Y and Z directions, diagonally, or rotatable in the XY plane, and/or tiltable or capable of being angled to enable additional degrees of freedom of the build platform 101 as desired to accommodate different tools and AM applications.

The AM system 100 may also include one or more tool station 105. As illustrated in FIG. 1, the AM system 100 includes a tool station 105-1, 105-2, 105-3, through 105-n. The tool station 105 functions as a truss for supporting one or more tools 107 used during the AM process. The motion platform 103 moves the build platform 101 along the Xp or Yp direction under the one or more tool stations 105 during production to enable access for the tools 107 associated with each tool station 105 to the build platform 101 during production. In some instances, the tool station 105 may be independent of adjacent tool stations 105. In other instances, one or more tool stations 105 may be independent of one or more adjacent tool stations 105. For example, one or more tool stations 105 may be independently controlled such that each (or a plurality) of tool stations 105 define an environment that is similar to or different from one or more adjacent tool stations 105. In another example, one or more tool stations 105 define one or more tool station environments, wherein the one or more tool station environments are similar to or different from an environment external to the one or more tool stations 105. The environment external to the one or more tool stations may be adjacent tool stations, atmospheric environment, or combinations and variations thereof. The environment of the tool station(s) 105 may include, but is not limited to, controlling humidity, temperature, air quality (e.g., HEPA filter), producing a clean room, and combinations and variations thereof.

The one or more tools 107 are mounted on each of the tool stations 105. The individual tools 107 associated with a respective tool station 105 may be further grouped into a tool cluster 109. Each tool cluster 109 may include any number of tools 107 from one to n tool 107 and the individual tools 107 in a respective tool cluster 109 may be the same or different from other tools 107 in the tool cluster 109. The tool clusters 109 associated with each of the tool stations 105 may be the same or different from other tool clusters and include a different number and different type of tools 107. The tools 107 may include calibration tool and inspections tools, such as cameras, location based sensors or other sensors, AM tools, such as conductive and dielectric print tools, VAM tools, digital lithographic patterning tools utilizing lasers and digital micromirror devices (DMD, dispensing tools, and pre-and post-processing tools, such as cleaning and curing/laser/UV tools.

In some embodiments, the tool station 105, enables the tools 107 or tool clusters 109 mounted thereon to move in the X, Y and/or Z directions, and combinations thereof. In this way, the tools 107 or tool cluster 109 mounted on respective tool stations 105-1 105-2, 105-3, through 105-n are respectively movable in the X1, X2, X3, Y1, Z1, Y2, Z2, Y3, Z3, Xn, Yn, Zn directions. In one example, as the build platform 101 is moved in the Xp or Yp directions the tools 107 or tool clusters 109 move in the Y and Z direction associated with respective tool stations 105 enabling AM in multiple degrees of freedom.

As described above, the tool station 105-1, 105-2, 105-3, through 105-n may be movable in a X, Y, and/or Z direction, and combinations thereof. In this way, as the build platform 101 is moved in the Xp or Yp directions under each of the tool stations 105-1, 105-2, 105-3, through 105-n, the respective tools 107 or tool clusters 109 associated with the tool stations 105-1, 105-2, 105-3, through 105-n, can be more precisely controlled in the X or Y direction. This may be desirable as the build platform 101 may be stationary under each tool station 105 while being processed.

In some embodiments, the build platform 101 may be movable and/or rotatable in the X, Y, and/or Z directions, diagonal, tiltable, and combinations thereof relative to the tool station 105 and at least a portion of the tool station 105, such as the tools 107 or the tool clusters 109, may be movable relative to the build platform 101. In some embodiments, at least one build platform 101 of the plurality of build platforms 101 may be movable and/or rotatable in the X, Y, and/or Z directions, diagonal, tiltable, and combinations thereof relative to the tool station 105 and at least a portion of the tool station 105, such as the tools 107 or the tool clusters 109, may be movable relative to the build platform 101. In some embodiments, the build platform 101 may be movable and/or rotatable in the X, Y, and/or Z directions, diagonal, tiltable, and combinations thereof relative to at least one tool station 105 of the plurality of tool stations 105 and at least a portion of at least one tool station 105 of the plurality of tool stations 105, such as the tools 107 or the tool clusters 109, may be movable relative to the build platform 101. In some embodiments, at least one build platform 101 of the plurality of build platforms may be movable and/or rotatable in the X, Y, and/or Z directions, diagonal, tiltable, and combinations thereof relative to at least one tool station 105 of the plurality of tool stations 105 and at least a portion of at least one tool station 105 of the plurality of tool stations 105, such as the tools 107 or the tool clusters 109, may be movable relative to the build platform 101.

For example, the build platform 101 may be stationary under tool station 105-1, whereby the respective tools 107 or tool cluster 109 mounted on the tool station 105-1 are moved in the X1, Y1, and ZI direction to perform a first stage of the AM operation. The build platform 101 is then moved by the motion platform 103 in the Xp or Yp directions to be accurately positioned relative to the tool station 105-2, whereby the respective tools 107 or tool cluster 109 mounted on the tool station 105-2 are moved in the X2, Y2, and Z2 direction to perform a second stage of the AM operation. This process may be repeated for n tool station axes 105. This may allow the build platform 101 to be moved to a determined X or Y position for a particular tool station stage of the AM operation while the tools 107 and tool cluster 109 are moved in the X, Y, and Z direction relative to the stationary build platform 101. In some embodiments reducing the movement of the build platform 101 may facilitate calibration and maintaining calibration of the build platform 101.

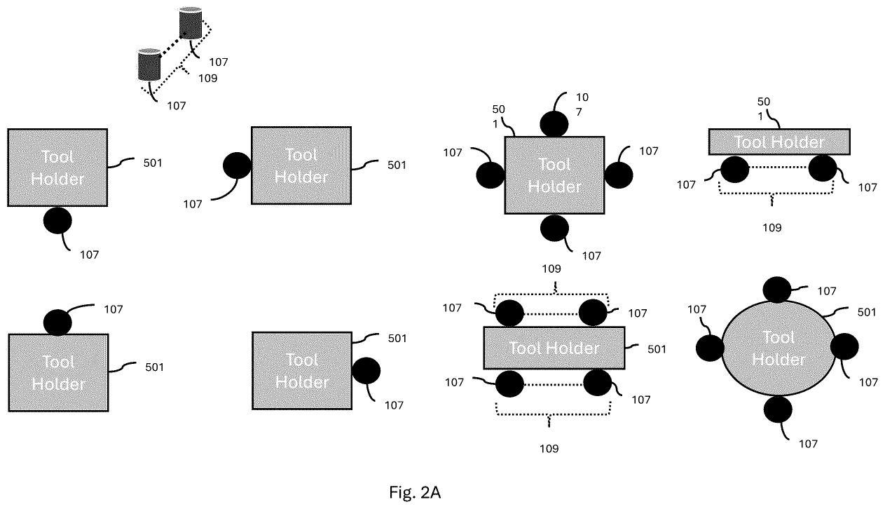

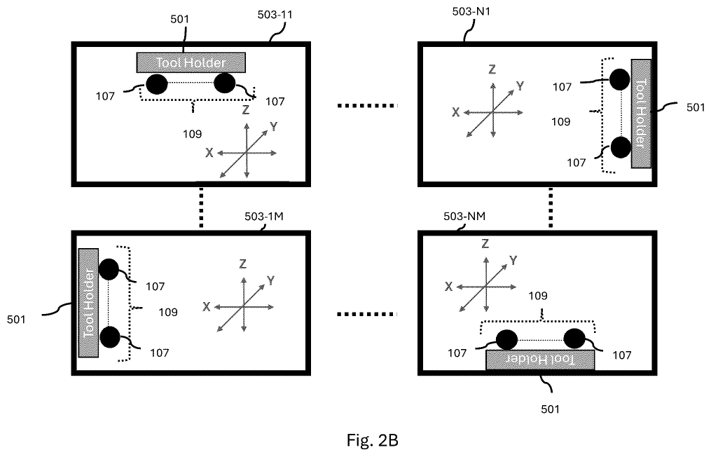

Referring now to FIG. 2A, shown are various embodiments of the tools 107 a part of tool clusters 109 mounted on tool holders 501 each within a tool station as described herein. In some embodiments, one or more tools 107 may be grouped together into tool clusters 109. The individual tools 107 and tool clusters 109 may be mounted on a tool holder 501 which is in turn mounted on one of the tool stations 105. The tool holder 501 may be a swappable mounting mechanism for the tool 107 and tool cluster 109 which can be quickly and easily interchanged and mounted on the tool station 105. In some embodiments, the tools 107 and the tool clusters 109 may be fixedly or rotatably mounted on the tool holder 501. In some embodiments, the tool holder 501 may be fixed or include rotational capabilities and allows for multiple shapes and tool arrangements, tool positioning, for example square, rectangular, circular, oval, or planar tool holder shapes, although not limited thereto. In some embodiments, the tool holder 501 is actuated (moved) using program control across its associated axes. In some embodiments, the tool holder 501 may be an automated tool holder. The automated tool holder may be configured to exchange one or more tools (e.g., tool exchanger). The tool exchanger may be a single-sided tool exchanger, a double-sided tool exchanger, or a three plus-sided tool exchanger. The automated tool holder may be a magnetic tool holder, a robotic tool holder, a mechanical tool holder, and combinations and variations thereof. As used herein, the tool holder 501 and the automated tool holder may be used interchangeably unless noted expressly otherwise.

In some embodiments, the automated tool holder 501 may include a tool changer having a docking station positioned adjacent to a set of tool stations. The docking station facilitates the secure attachment and detachment of tool holders during transitions between manufacturing phases. The tool holders are equipped with coupling mechanisms that allow them to interface with the docking station in multiple configurations. The tool holders are also capable of rotational and translational movement along predefined axes to align the appropriate tool with the manufacturing equipment.

In one embodiment, the tool changer includes a robotic arm for positioning the tool holders at precise locations within the manufacturing environment. The robotic arm assists in reducing the time taken to switch tools and ensures that each tool is correctly aligned before any operation begins.

In another embodiment, the automated tool changer mechanism may be dual sided, and actuate tool exchanges across multiple tool holding positions. In this manner, the density, and hence number of tools that may be exchanged, is increased.

Referring now to FIG. 2B, shown is a tool holder 501 mounted in a tool station 503. In some embodiments, the tool holder 501, and associated tool 107 and tool cluster 109, may be mounted in a tool station 503. The tool station 503, may be circular, square, rectangular, or another polygonal shape and the tool holder 501 may be mounted on any side of the tool station 503. The tool holders 501, and tools 107 or tool clusters 109, are movable in the X, Y, and Z directions within the tool station 503. In some embodiments, the tool 107 or tool cluster 109 may be mounted directly on the tool station 503. In some embodiments, the tool stations 503 may be the same as the tool stations 105. In some embodiments, the tool station 105 acts as truss supports for a gantry where one or more tool station 503 may be mounted on. In some embodiments, one or more tool stations 503 may be arranged as a linear pipeline in series, as illustrated in FIG. 1 or may be arranged in two dimensional arrays or n by m matrices, or may be positioned in various two dimensional arrangements. In this way, a build platform 101 may be moved under each of the tool stations 503 whereby the respective tools 107 associated with each tool station 503 perform a stage of an AM process.

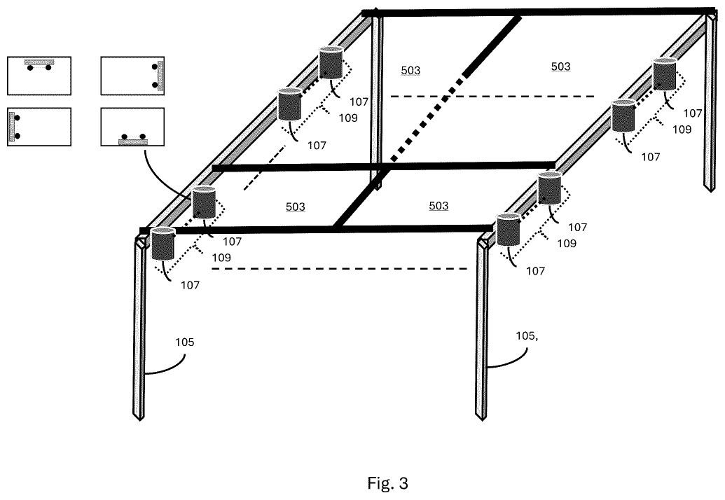

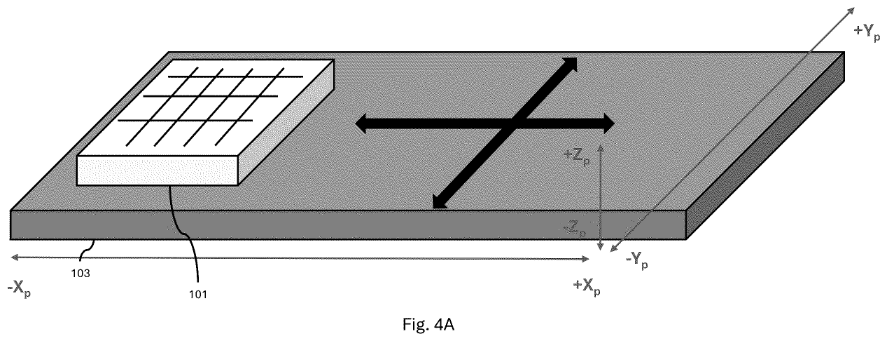

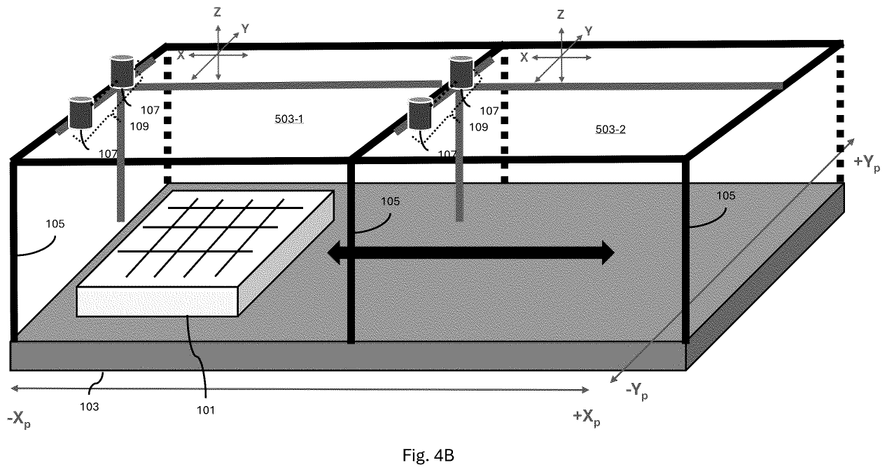

Referring now to FIG. 3, shown is a plurality of tool stations 503 in a n by m matrix. The tool stations 503 may be coupled to each other and/or one or more tool stations 105 to form a plurality of tool stations 503. The plurality of tool stations 503 may be positioned relative to a build platform 101 and motion platform 103 (shown in FIG. 4B), similar to a gantry, such that the build platform 101 can be moved under one or more of the tool stations 503 during a stage of an AM process.

Referring now to FIGS. 4A-4B, shown is the build platform 101 and the motion platform 103 in a linear arrangement. In some embodiments, the build platform 101 may be mounted on a fixed XYZ motion platform 103, or a floating, magnetically levitated capable motion platform 103. In such embodiments the build platform 101 may be movable in the Xp, Yp, and Zp directions over the motion platform 103. In some embodiments, one or more linearly arranged tool stations 503 may be arranged over the motion platform 103 such that respective tools 107 associated with each tool station 503 can perform a stage of an AM process.

As illustrated in FIG. 4B, shown is the AM system 100 with two tool stations 503 arranged in series. The two tool stations 503-1, 503-2, each have a tool cluster 109 mounted thereon. The tool clusters 109 being cable of XYZ motion within the tool station 503, over a single build platform 101 that is actuated in XYZ dimensions. The build platform 101 may be a fixed XYZ or magnetic motion platform. As the build platform 101 is moved under the first tool station 503-1 whereby the respective tool cluster 109 is moved in the X, Y, and Z directions to perform a first stage of the AM process. The build platform 101 is then moved in the Xp or Yp directions under the second tool station 503-2 whereby the respective tool cluster 109 is moved in the X, Y, and Z directions to perform a second stage of the AM process. This process may be repeated for any number of tool stations 503 to perform respective stages on an AM process as desired.

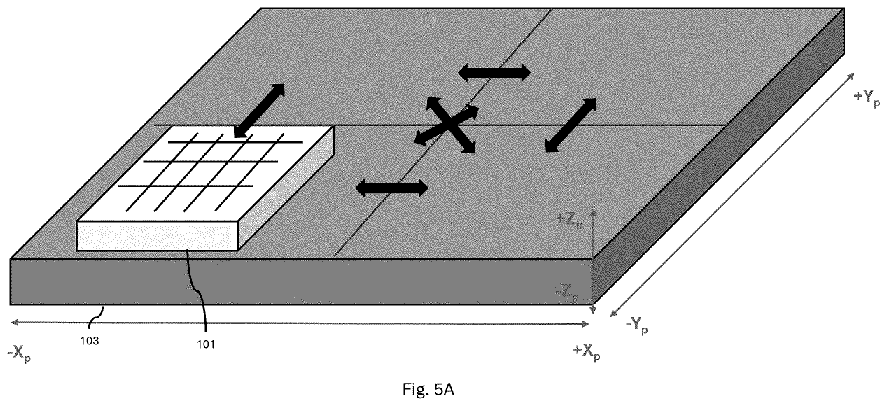

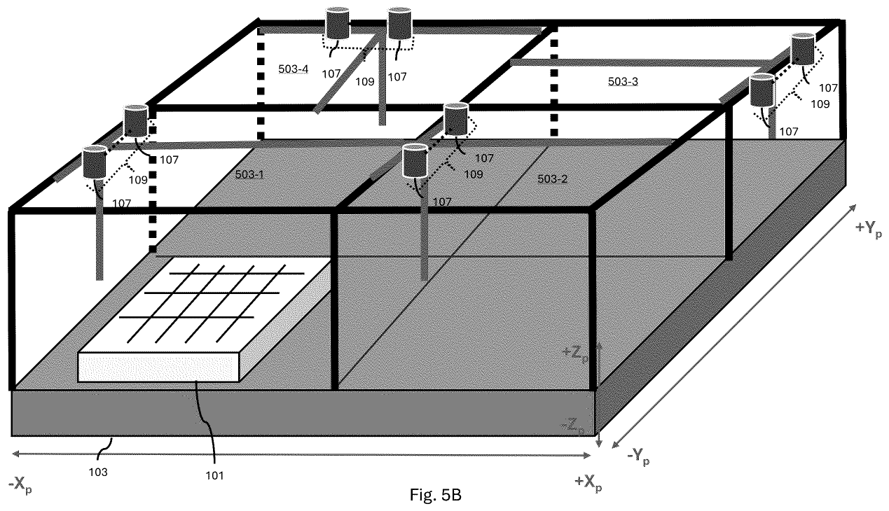

Referring now to FIGS. 5A-5B, shown is a build platform 101 and a motion platform 103 in a two dimensional configuration. In some embodiments, the motion platform 103 may be arranged under a N×M grid of tool stations 503 within an (Xp, Yp) coordinate matrix. The motion platform 103 may move the build platform 101 using a fixed XYZ motion platform, or magnetic motion platform to transfer the build platform 101 to any adjacent element, e.g., tool station 503, at any desired point in time in accordance with tool path configuration, orchestration and controls. The function of the magnetic motion platform then is to move one or more build platforms 101 to their desired location e.g., tool station 503, tool station 105, tool 107, or tool cluster 109, where one or more stages of an AM process may be performed.

It should be appreciated that a magnetic motion platform may utilize a build platform 101 as a mobile build platform described in U.S. Provisional Application Ser. No. 63/741189 filed Jan. 2, 2025 entitled “Mobile Build Platform System and Methods of Use Thereof”, the contents of which are incorporated by reference herein. The magnetic motion platform may further be configured in the manner described in U.S. Provisional Application Ser. No. 63/809075 filed May 20, 2025 entitled “Magnetic Hold Down System for Additive Manufacturing Platforms and Method of Operation”, the contents of which is incorporated by reference herein.

As illustrated in FIG. 5B, four tool stations 503-1, 503-2, 503-3, 503-4, are arranged in a N×M or 2×2 configuration, with each tool station 503-1, 503-2, 503-3, 503-4 each having a tool cluster 109 mounted thereon. The tool clusters 109 being capable of XYZ motion within the tool station 503, over a single build platform 101 that is actuated in XYZ dimensions. As shown, the respective tool clusters 109 may be mounted on any side of the tool station 503-1, 503-2, 503-3, 503-4. The build platform 101 may be a fixed XYZ motion platform or magnetic motion platform. The build platform 101 is moved under the first tool station 503-1 whereby the respective tool cluster 109 is moved in the X, Y, and Z directions to perform a first stage of the AM process. The build platform 101 is then moved in the Xp or Yp directions under the second tool station 503-2 whereby the respective tool cluster 109 is moved in the X, Y, and Z directions to perform a second stage of the AM process. The build platform 101 is then moved in the Xp or Yp direction under the third tool station 503-3 whereby the respective tool cluster 109 is moved in the X, Y, and Z directions to perform a third stage of the AM process. The build platform 101 is then moved in the −Xp or −Yp direction under the fourth tool station 503-4 whereby the respective tool cluster 109 is moved in the X, Y, and Z directions to perform a fourth stage of the AM process. This process may be repeated for any number of tool stations 503 to perform respective stages on an AM process as desired. Further it is appreciated that the build platform 101 may move to any adjacent element, for example from first tool station 503-1 to the fourth tool station 503-4, or in any direction, for example from the third tool station 503-3 to the second tool station 503-2 as desired. In some embodiments, more than one stage of the AM process, for example a first stage of the AM process may be performed under first tool station 503-1, a second stage under the second tool station 503-2, and a third stage under the first tool station 503-1, whereby the build platform 101 is moved between the first and second tool station 503-1, 503-2 one or more times to perform N stages of the AM process as desired.

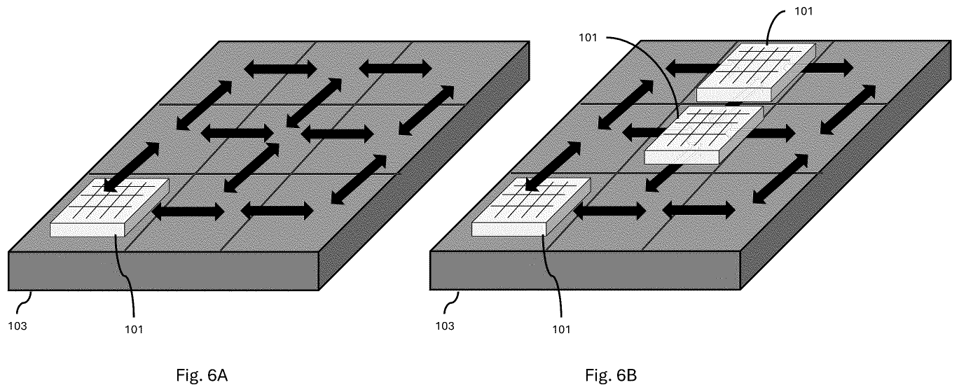

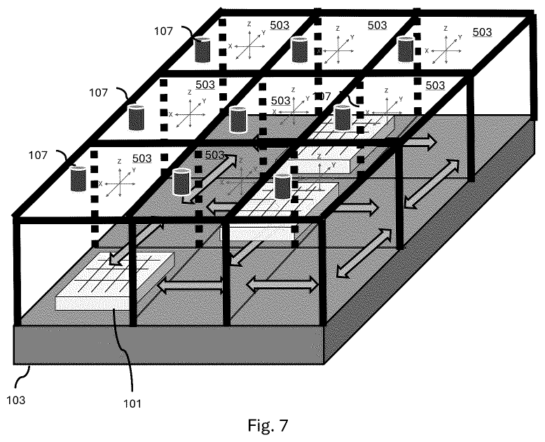

Referring now to FIGS. 6A-6B, shown is one or more build platforms 101 on a motion platform 103 arranged in a N×M matrix. As illustrated in FIGS. 6A-B, a N×M matrix motion platform 103, 3×3 in this case, is shown. In FIG. 6A, the build platform 101 may be a fixed or mag-lev-based model since there is one build platform 101. In FIG. 6B multiple build platforms 101 may be orchestrated in parallel. In such embodiments a magnetic levitated motion platform may be used to move the one or more build platforms 101. The overhead tool stations 503 are shown in FIG. 7. In some embodiments, the one or more build platforms 101 may be further movable in the Y and Z directions, diagonally, or rotatable in the XY plane, and/or tiltable or capable of being angled to enable additional degrees of freedom of the build platform 101 as desired to accommodate different tools and AM applications.

FIG. 7 illustrates a similar AM arrangement as depicted in FIG. 5B with a N×M matrix confirmation, in this case a 3×3 matrix. Each grid in the 3×3 matric includes a tool station 503 (each with a tool 107, tool cluster 109 or tool holder 501 with XYZ motion capabilities). The 3×3 matrix further includes multiple concurrent build platforms 101 (3 shown), each of which can move among the nine tool stations 503. This embodiment illustrates the concept of a matrix arrangement of multiple tool stations 503, working in coordination to fabricate across multiple build platforms 101. Each build platform 101 being independently movable over the motion platform 103, for example using magnetic levitation to orchestrate the movement to a given tool station 503 where the fabrication process occurs in accordance with the desired sequence of manufacturing operations. It should be appreciated that the build platforms 101 as mobile build platforms may each move in independently controlled X, Y, or diagonal directions between any set of tool stations.

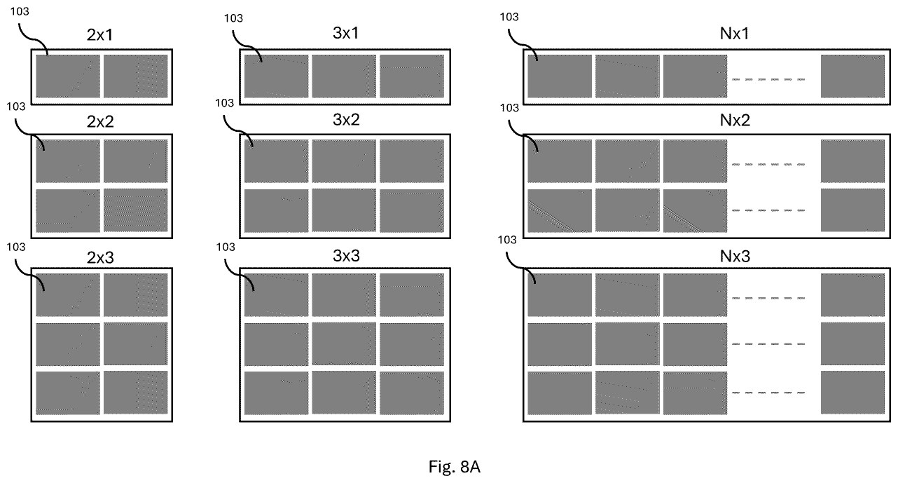

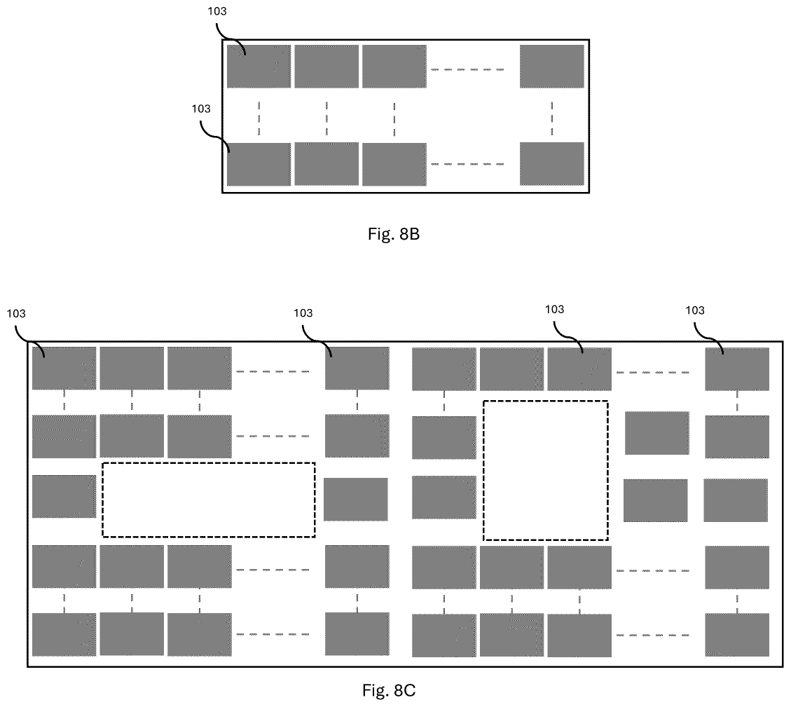

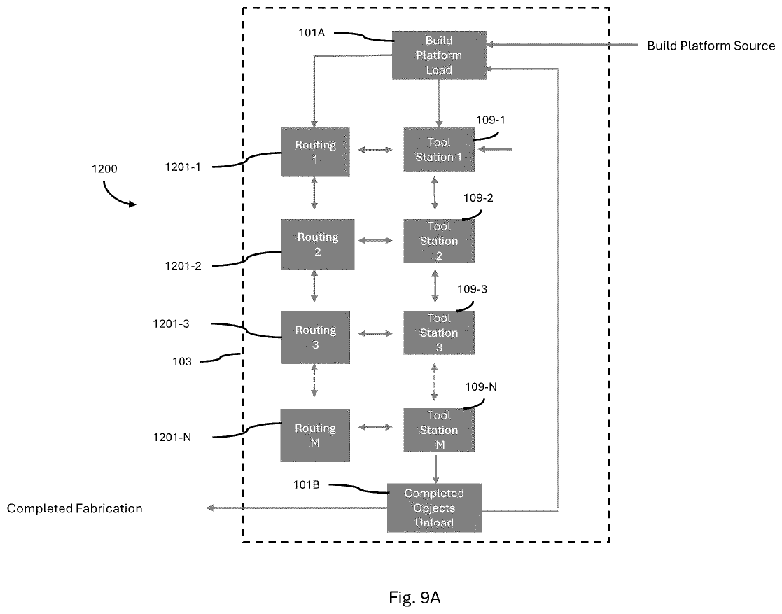

Referring now to FIGS. 8A-8C, shown are different motion platform 103 configurations. The motion platform 103 may be configured into multiple arrangements to support a variety of the number of concurrently processed build platforms 101, or level of orchestration (motion path and timing among all elements) across tools 107 and the manufacturing processes. For example, as depicted in FIG. 8A, the motion platform 103 may be arranged in a 2×1, 3×1, N×1, 2×2, 3×2, N×2, 2×3, 3×3, N×3 arrangements as desired depending on the particular application and throughput needs. The motion platform 103 may be arranged in any arrangement, which is depicted as an N×M arrangement of FIG. 8B. The motion platform 103 may be arranged in an irregular N×M arrangement, an example of which is depicted in FIG. 8C. Areas depicted as void may include fixed tools, tool stations, robotic tools, regions for support apparatus, equipment or functions such as material supply, power, cooling, environmental control, or simply void regions. However, it should be understood that any irregular N×M arrangement may be produced without departing from the spirit/scope of this disclosure.

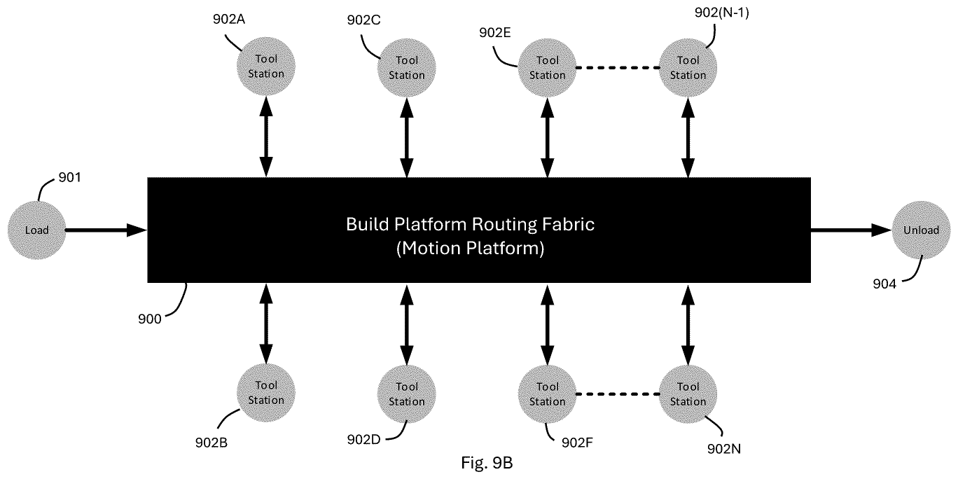

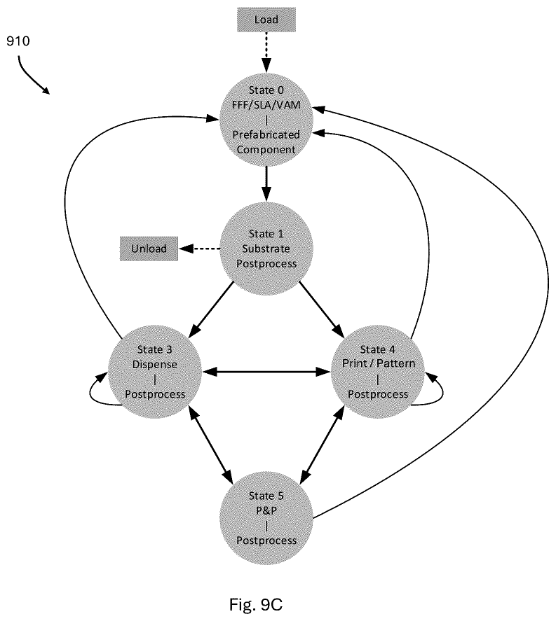

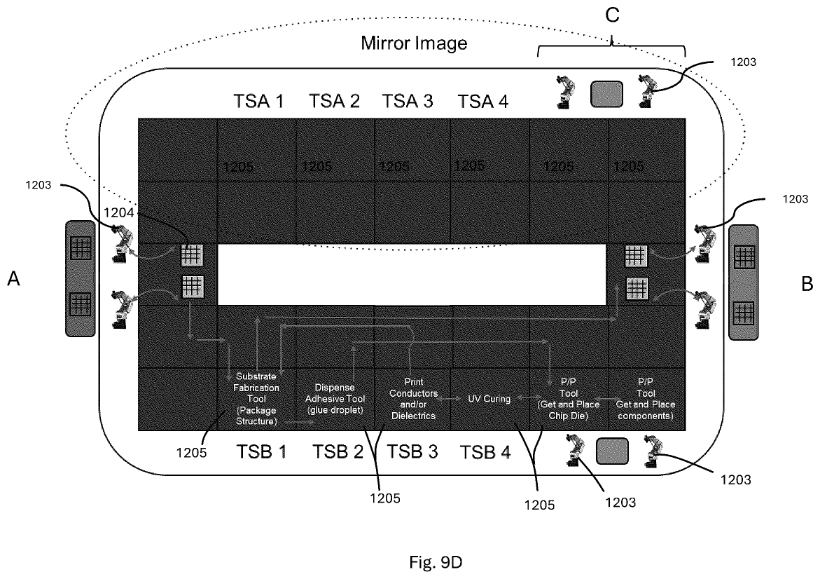

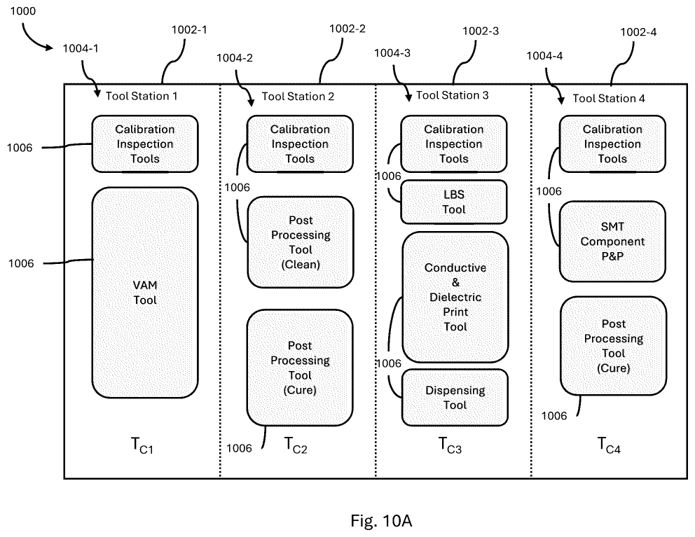

Referring now to FIG. 9A shown is a schematic and a flowchart view of an exemplary AM system 1200 in a 3×M matrix arrangement. Build platforms 101 are loaded into the AM system 1200 at the Build Platform Load 101A. Build platforms may be recirculated from 101B as fabrication jobs complete, or in an embodiment, new build platforms may be loaded from an external source manually, or via a robotic or other automated process. For example, in an AM manufacturing process a substrate required device, part, or support related component may be added to the build platform 101. Each build platform 101 then moves towards tool station 1 in a queue formation, and is processed across tool stations 1-M as desired. The AM platform buffers 1201 are routing regions that provide a non-blocking highway for the movement of build platforms 101 between all the tool stations 1-M. for example, some of the tool stations 1-M may require more processing time and in order to facilitate increased throughput, the build platforms 101 may be held in a routing region instance 1201. Once the build platform 101 is processed across tool stations 1-M, the final station is the “build platform unload”, identified as element 101B, whereby an operator or robot arm may unload completed jobs to the completed fabrication zone or may be sent back into the queue at build platform load station 101A for processing.

Referring now to FIGS. 9B-9C, shown are system diagrams of an adaptive additive manufacturing system work flow according to some embodiments of the present disclosure. As illustrated in FIG. 9B, in some embodiments, the adaptive additive manufacturing system have a non-blocking bus whereby build platforms 101, or mobile build platforms or materials are loaded 901. The mobile build platforms are then routed along the non-blocking bus 900 (motion platform) to various tool stations 902A-902N for processing. The mobile build platforms or finished products are then unloaded 904 from the non-blocking bus. In an embodiment, this process representing a method for additive manufactured electronics or semiconductor packaging is conceptualized as flowchart and state sequence 910 in FIG. 9C.

In the state sequence 910, the build platform 101 moves between different states 912-920 where different processes are preformed, including a state 0 (FFF/SLA/VAM prefabricated components), state 1 (substrate postprocess), state 3 (dispense and postprocess), state 4 (print/pattern & postprocess), state 5 (pick & place and postprocess). It should be appreciated that the illustrated states are for example purposes and the state sequence 910 can include more or fewer states.

Referring now to FIG. 9D, shown are schematic view of adaptive additive manufacturing system layouts and process steps according to some embodiments of the present disclosure. In some embodiments, robotic arms or pick-and-place devices 1203 may be used to load device carriers 1204, onto one or more mobile build platforms, shown at location A. It should be appreciated, however, that the load location may be at various locations relative to the layout and the identification of location A is to aide in the explanation of the described layout. The mobile build platforms are routed through the system to various tool stations 1205 for processing, whereby each tool station 1205 contributes to the manufacturing process of the target object. In some embodiments, the adaptive additive manufacturing system may have two or more parallel tracks or additional regions dedicated for mobile build platform movement and routing in order to process the desired number of mobile build platforms and support the manufacture of multiple objects concurrently. The additional regions are used for mobile build platform movement and routing to achieve non-blocking movement (avoidance of obstacles, movement stalling or deadlock scenarios) of mobile build platforms to achieve maximum flexibility, performance and throughput of the manufacturing process. Once the mobile build platforms are finished routing though the system, robotic arms or pick-and-place devices 1203 may be used to unload the mobile build platform device carriers or the manufactured target(s) from each mobile build platform, shown at location B. It should be appreciated, however, that the unload location may be at various locations relative to the layout and the identification of location B is to aide in the explanation of the described layout. In some embodiments, additional robotic arms or pick-and-place devices 1203 may be positioned along the mobile build platform route as a tool station in order to remove or add to the mobile build platform, materials or components, and combinations thereof, from a material or component device supply source(s), shown at location C. It should be appreciated, however, that the additional location may be at various locations relative to the layout and the identification of location C is to aide in the explanation of the described layout. For example, the robotic arms or pick-and-place devices 1203 may add electronic components from trays or reel sources for placement onto precise locations onto the target object under fabrication. In another example the robotic arm or pick-and-place device may add additional materials or a prefabricated structure to the mobile build platform for further processing, although not limited thereto.

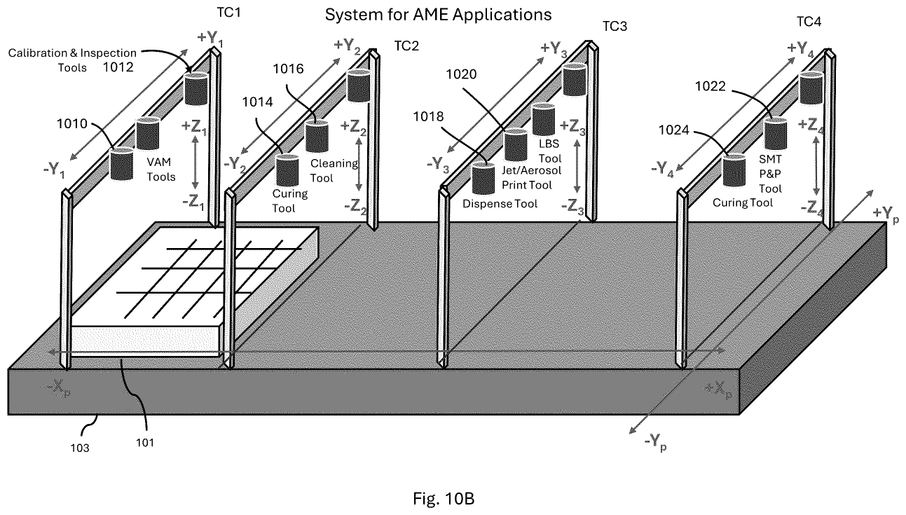

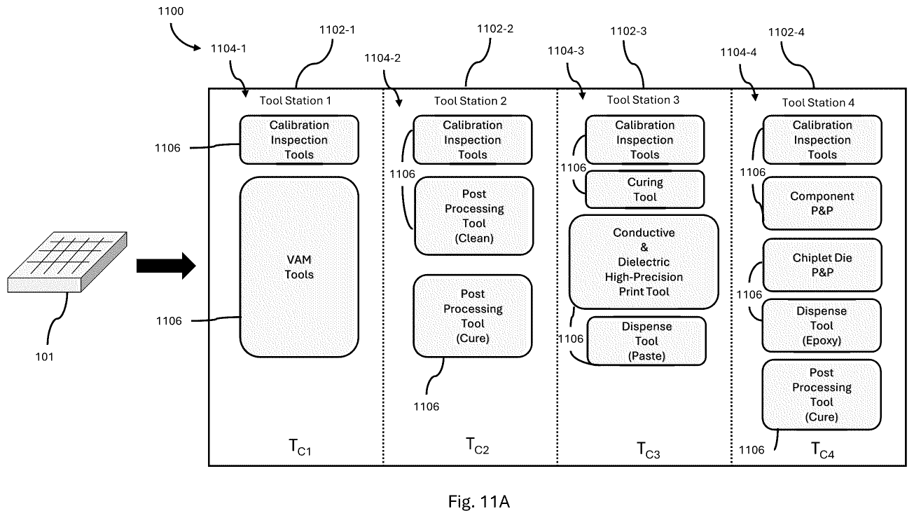

Referring now to FIGS. 10A-10B, shown is a schematic and a perspective view of an example 4×1 AM system for AME applications 1000. The AME applications may include 3D Antenna, Sensor/AI Edge, IoT manufacturing application. Tool station 1 1002-1 (which may be similar to tool station 105, 503) may have tool cluster TC1 1004-1 (which may be similar to tool cluster 109) mounted thereon and tool cluster TC1 may include a variety of tools 1006 (which may be similar to tools 107). For example, the tools 1006 may include, but are not limited to, VAM tools 1010 and calibration and inspection tools 1012. Tool station 2 1002-2 may have tool cluster TC2 1004-2 mounted thereon and tool cluster TC2 may include, but is not limited to, post processing tools for cleaning, post processing tools for curing 1014, and calibration and inspection tools 1016. Tool station 3 1002-3 may have tool cluster TC3 1004-3 mounted thereon and tool cluster TC3 may include, but is not limited to, curing tools (e.g., laser curing, light beam sintering), conductive and dielectric printing tools, jet/aerosol printing tools 1020, dispensing tools 1018, and calibration and inspection tools. Tool station 4 1002-4 may have tool cluster TC4 1004-4 mounted thereon and tool cluster TC4 may include, but is not limited to, SMT component P&P 1022, post processing tools for curing 1024, and calibration and inspection tools. The build platform 101 may be a VAM substrate VAT and may be processed linearly by each of the tool stations 1-4 1002. At each manufacturing stage, the build platform is moved under the respective tool stations and the calibration and inspections tools will determine the relative position of the build platform 101. Then a respective manufacturing stage operation is performed by each of the respective tools at each tool station 1-4. Although various tools are depicted at the different tool stations, it should be understood that tool locations and tool functionality may be rearranged depending on the desired operation, without departing from the spirit/scope of this disclosure.

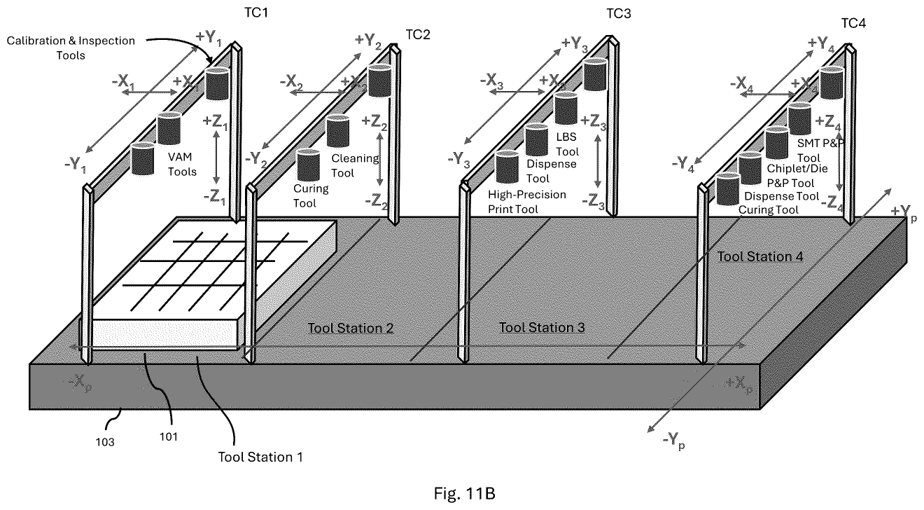

Referring now to FIGS. 11A-11B, shown is a schematic and a perspective view of an example 4×1 AM system 1100 for semiconductor SiP/SoP chip package fabrication. The semiconductor SiP/SoP chip package fabrication application may include general Semiconductor Packaging, Chiplet/HI, Neuromorphic AI Computing, Edge/Sensor Intelligence. Tool station 1 1102-1 (which may be similar to tool station 105, 503) may have tool cluster TC1 1104-1 (which may be similar to tool cluster 109) mounted thereon and tool cluster TC1 may include a variety of tools 1106 (which may be similar to tools 107). For example, the tools 1106 may include, but are not limited to, VAM tools and calibration and inspection tools. Tool station 2 1102-2 may have tool cluster TC2 1104-2 mounted thereon and tool cluster TC2 may include, but is not limited to, post processing tools for cleaning, post processing tools for curing, and calibration and inspection tools. Tool station 3 1102-3 may have tool cluster TC3 1104-3 mounted thereon and tool cluster TC3 may include, but is not limited to, curing tools (e.g., laser curing, light beam sintering), conductive and dielectric printing tools, dispensing tools, and calibration and inspection tools. Tool station 4 1102-4 may have tool cluster TC4 1104-4 mounted thereon and tool cluster TC4 may include, but is not limited to, SMT component P&P, post processing tools for curing, chiplet die P&P, dispensing tools, and calibration and inspection tools. In some embodiments, for Chip/HI Applications and/or advanced package manufacturing, additional X1-4 axes added for high-precision (nm accuracy/repeatability) XYZ stage movements and positioning may be utilized. The build platform 101 may be a VAM substrate VAT and may be arranged to follow JEDEC standards for matrix chip trays. The build platform 101 may be processed linearly by each of the stations 1-4. At each manufacturing stage the build platform is moved under the respective tool station and the calibration and inspections tools will determine the relative position of the build platform 101. Then a respective manufacturing stage operation is performed by each of the respective tools at each station 1-4 1102. Although various tools are depicted at the different tool stations, it should be understood that tool locations and tool functionality may be rearranged depending on the desired operation, without departing from the spirit/scope of this disclosure.

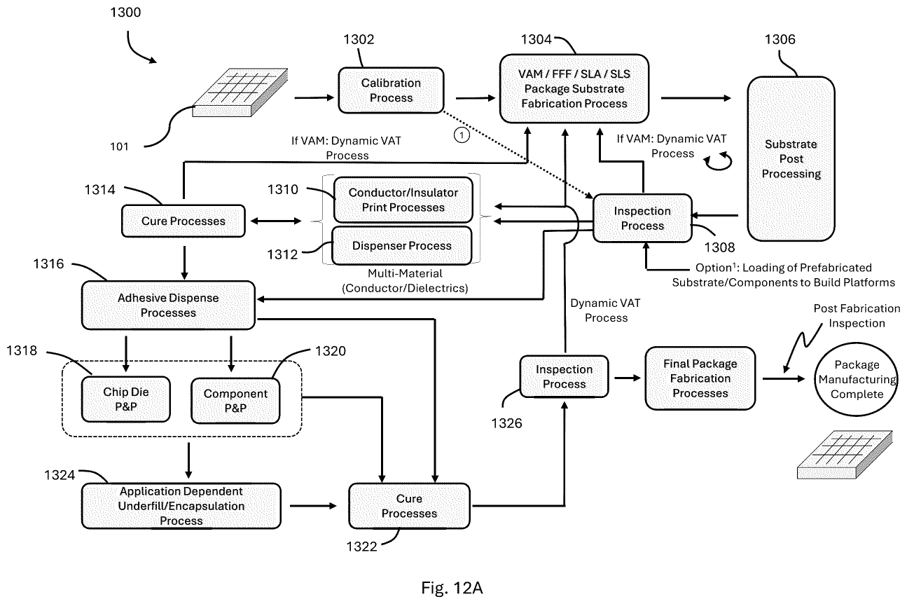

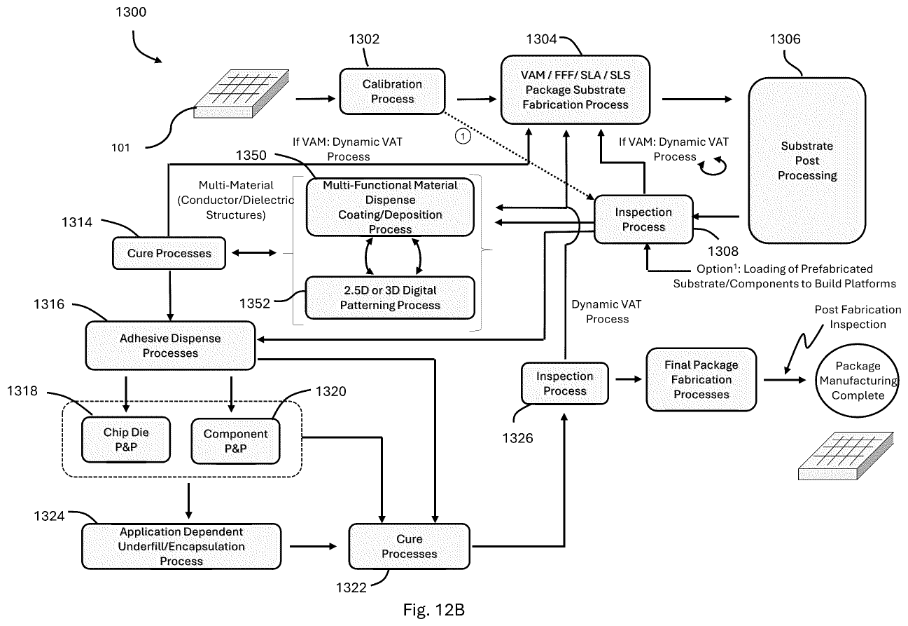

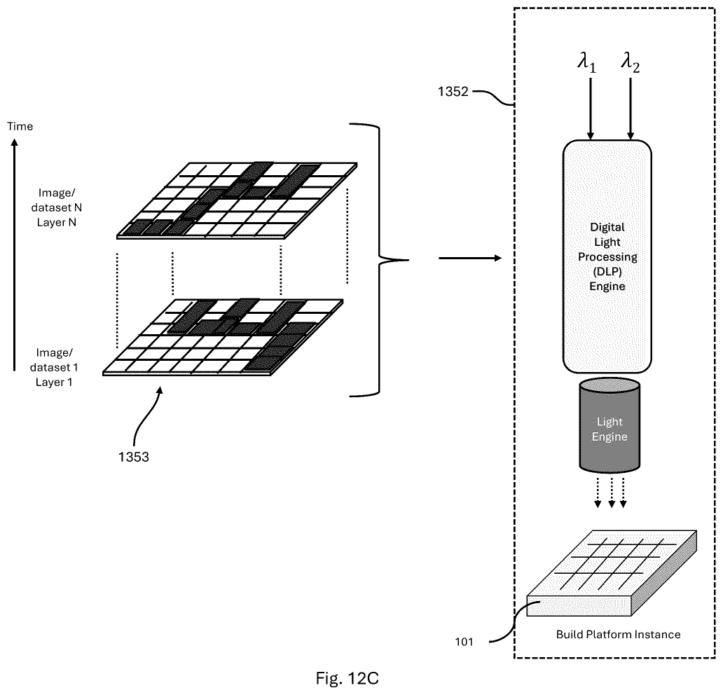

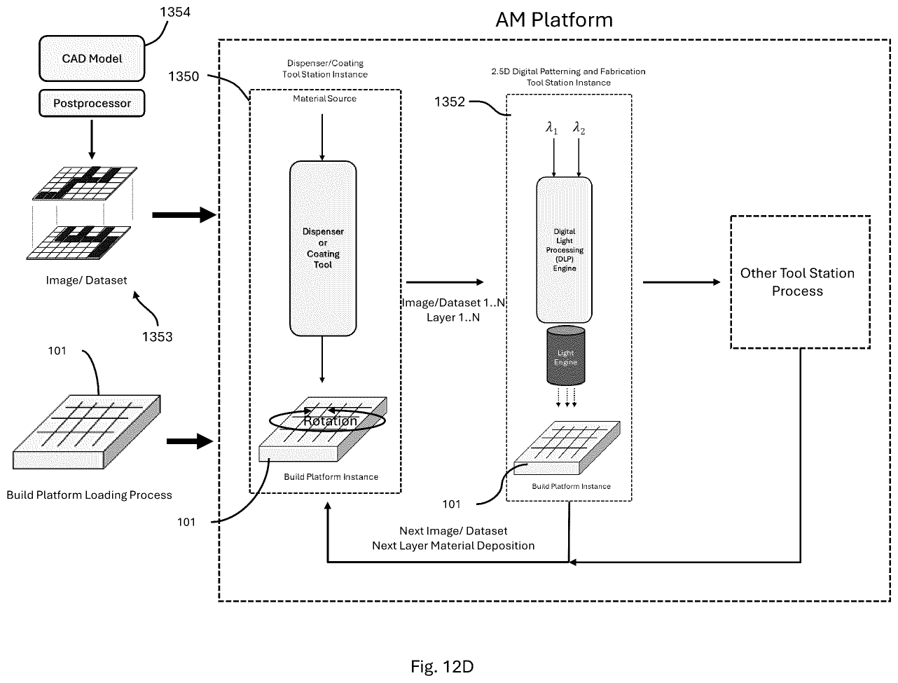

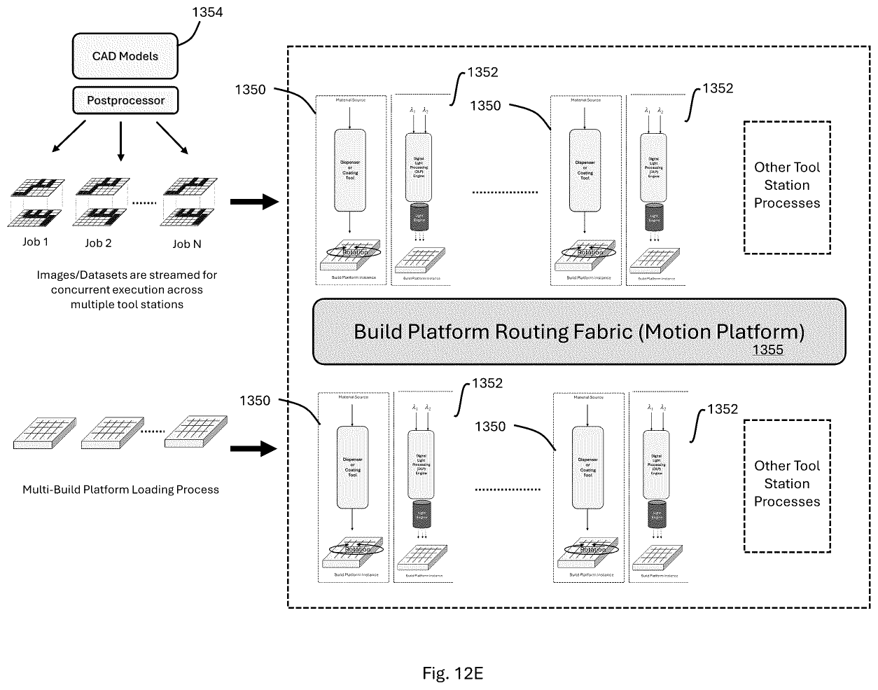

Referring now to FIGS. 12A-12B, shown are flow charts of exemplary AME processes for semiconductor chip package fabrication. First a Dynamic Substrate VAT Array (JEDEC Matrix Configuration) 101, a Multi-Dimensional Build-Platform 101, or a Mobile Build Platform 101, or conventional build platform is sent through a calibration process to ensure alignment or calibration of each build platform relative to all tool stations. After the build platform is calibrated a package substrate fabrication process begins through at least one substrate fabrication method (e.g., VAM, FFF, SLA, SLS) including the option of loading a prefabricated substrate. Once the substrate object has been manufactured in the Package Substrate Fabrication Process the object is passed to a substrate cleaning process, a substrate curing process, and an inspection process. In the case of a prefabricated substrate, the prefabricated substrate is directed to an inspection process. The VAM, substrate cleaning process, substrate curing process, and inspection process may be repeated as desired. For example, it may be desirable to reposition the substrate or reorient for different access angles if say on a multi-axis platform, or inspect and/or test the manufactured object at different fabrication process points, or change the behavior in curing process between various fabrication phases, for example there may be different materials that need to be treated differently at different times.

In one embodiment, as shown in FIG. 12A, after the manufactured object (or substrate) passes the inspection process, the system may perform 3D printed electronic processes (such as jetting, aerosol, as non-limiting examples.) and dispenser-based 3D deposition processes, for example to fabricate multi-material conductor/dielectrics on the additively manufactured microsystems object, after which another curing process takes place. In an embodiment, the described 3D additive manufactured electronics process fabricates semiconductor packages. This includes but is not limited to the fabrication of chip die fan-outs, interconnection networks (such as RDL, interposers) and a plurality of die attachment connection methods such as die pad to C4/C2 bumps, lead frames and other I/O location types.

In an embodiment, the process 1300 begins in block 1302 with a calibration process. The process then proceeds to block 1304 where the package substrate is fabricated before being subjected to post processing in block 1306. Once the post processing is completed, the process proceeds to block 1308 where an inspection is performed. In an embodiment, an optional step of loading prefabricated substrates or components to the build platform 101 may be performed.

Once the inspection is completed, the process may perform different steps depending on the configuration of the object being fabricated. In one embodiment, the process proceeds to block 1310, 1312 where conductor/insulator print/deposition processes are performed. It should be appreciated that this may be a multi-material process. Once the conductor/insulator portions are deposited, the process 1300 proceeds to block 1314 where the materials are cured.

The process 1300 then proceeds to block 1316 where adhesive material is dispensed to allow the placement of either chips/circuitry in block 1318 or other components in block 1320, such as by using a pick and place process. After dispensing of the adhesive or placement of the chip/components, a curing process may be performed in block 1322. In some embodiments, additional material may be deposited in block 1324 for underfill or to encapsulate components prior to curing in block 1322.

The process 1300 then proceeds to block 1326 where an inspection is performed prior to any final fabrication processes or post fabrication inspection. It should be appreciated that the process 1300 provides for flexibility in the configuration of the fabrication process to accommodate the target object(s) being fabricated. In one or more embodiments, the process 1300 may loop back to block 1304 for additional fabrication of additional package substrates.

In an embodiment, as shown in FIG. 12B, the process 1300 begins in block 1302 with a calibration process. The process then proceeds to block 1304 where the package substraight is fabricated before being subjected to post processing in block 1306. Once the post processing is completed, the process proceeds to block 1308 where an inspection is performed. In an embodiment, an optional step of loading prefabricated substrates or components to the build platform 101 may be performed.

Once the inspection is completed, the process may perform different steps depending on the configuration of the object being fabricated. In one embodiment, the process proceeds to block 1350, 1352, where the system performs a multi-functional material dispense coating/deposition process and/or a 2.5D or 3D digital patterning process. The multi-functional material dispense coating/deposition process and/or the 2.5D or 3D digital may utilize a direct light processing (DLP) engine.

In an embodiment, the dispense coating/deposition process of block 1350, 1352 deposes a uniform thickness of material for further processing by the 2.5D or 3D digital patterning process that defines conductive and insulating geometries that are then cured into permanent functional circuit structures. In an embodiment, coating uniformity can be achieved by utilizing the mobile build platform, dynamic VAT, or multi-dimensional build platform to implement spin coating method where the rotation velocity of the build platform is defined such that a desired material thickness is achieved, at block 1350. The coating process can be repeated in an iterative fashion to achieve a multi-layer stack, where each layer is patterned, at block 1352, then cured, at block 1314, into the desired structure, functionality, and characteristics, a new coating/deposition process occurs, and the process repeats until the desired X, Y, and vertical or Z axis arrangement of fabricated structures is completed. In some instances, a first layer may be patterned, at block 1352, then cured, at block 1314, then a second layer, in proximity to the first layer, may be patterned, at block 1352, then cured, at block 1314. It should be understood that the first patterned layer and the second patterned layer may be in direct contact with each other or may be indirect contact with each other, where one or more layers are positioned between the first and second patterned layers. It should also be understood that one or more layers may be provided before the first patterned layer is introduced.

Referring to the 2.5D digital patterning process, see FIGS. 12C-12E, in an embodiment, the 2.5D patterning process (e.g., similar to a 2.5D lithographic process), at block 1350, 1352, operates on the material that has coated a substrate structure by the dispense coating/deposition process previously described at block 1350. The material is wavelength selective, and may be configured on a voxel-by-voxel basis to form a conductive or insulating region based on exposure to specific wavelength and energy of light energy characteristics. The patterning, at block 1352, into conductive and insulating regions to form electrical networks is then controlled or programmatically defined by a sequence of 2D datasets (e.g., 2D images) 1353, at block 1354, that form the desired circuit pattern or functionality for a given layer. When multiple layers are fabricated, one on top of one another or one in proximity to another, the fabrication results in a vertical stacking, or 2.5D geometry, of conductor/insulating structures. The layers may define a thickness (t) that is at least partially defined by the material deposition or coating processes. In some instances, the mobile build platform 101 may be configured to move relative to the light source to expose a portion of the 2D dataset (e.g., 2D image) to the light energy at a given time and/or the light source may be configured to move relative to the mobile build platform. In other instances, the mobile build platform 101 may be configured to expose the entire 2D dataset (e.g., 2D image) to the light energy at a single time (e.g., mobile build platform may be stationary relative to the light source). In some embodiments, the 2D dataset (e.g., 2D image) may include metadata configured to instruct at least a portion of the process, such as, for example, exposure time, intensity, wavelength, etc.

In an embodiment, the set of 2D datasets (e.g., 2D images) define each of the two wavelengths of light at specific energy levels, in a selective method such as an image bitmask (where one state is associated to one wavelength/power configuration (λ1), and the other state is associated to a different wavelength/power configuration (λ2)), depending whether an insulating region or a conducting region is desired. It should be understood, however, that additional wavelength/power configurations may be incorporated without departing from the spirit/scope of this disclosure. After one layer is exposed to the light to identify the desired insulators and/or conductors, the layer may be exposed to another tool process (e.g., curing, pick and place, etc.). For example, after one layer is exposed to the light to identify the desired insulators and/or conductors, the layer is cured through the curing process and another layer is provided and exposed to the light. The process, continues on a layer by layer basis, and may be repeated for as many layers as desired, building a stack-up of layers in the Z axis (e.g., vertically). The combination of layers ultimately produces a 3D circuit structure including an insulating region and a conducting region in a desired pattern. After the desired 3D circuit structure is created, the desired 3D circuit structure may be exposed to another tool process (e.g., curing, pick and place, etc.) for example, after the desired 3D circuit structure is created, another curing process takes place.

In some instances, the 2D layer may be exposed to at least one wavelength/power configuration (λ1, λ2, n) to pattern an insulating region and/or a conducting region. The wavelength/power configuration may be configured to draw the desired pattern by exposing at least a portion of the 2D layer to the desired wavelength/power configuration. For example, the wavelength/power configuration may be configured to expose the 2D layer region by region and/or point by point to draw the desired pattern.

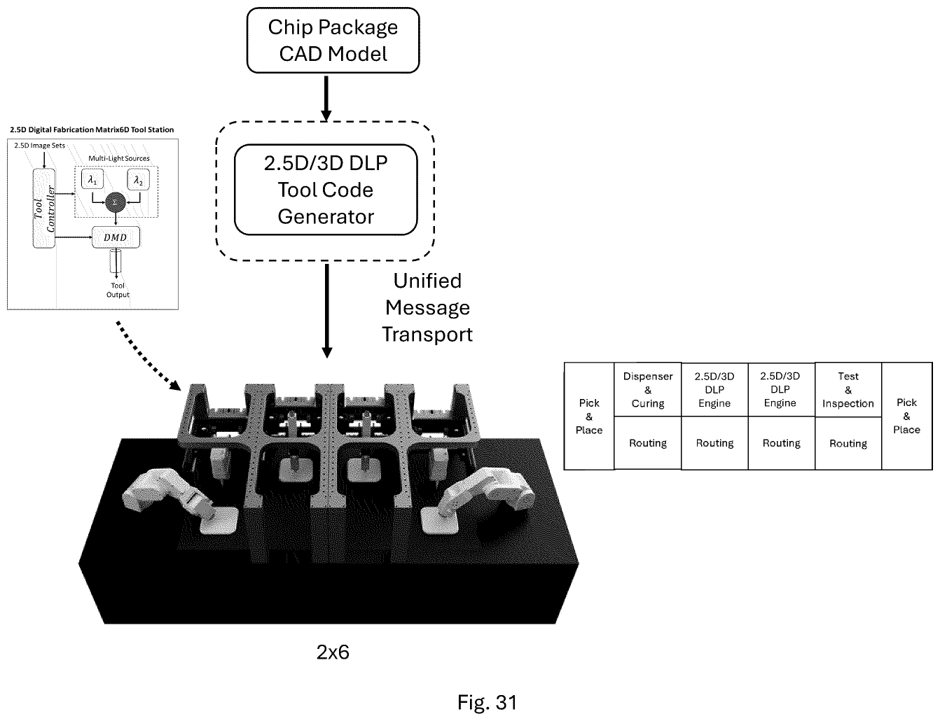

In some embodiments, referring to FIG. 12E, the 2.5D digital patterning process may include a plurality of tool stations. In some instances, one or more of the tool stations may be configured to perform a different task (e.g., dispenser/coating, curing, pick and place). The layout may be modular such that tool stations may be added or removed as required. In a non-limiting example, the tool stations may be situated in a N×M configuration and are transferred between tool stations by an N×M motion platform 1355. In a non-limiting example, the layout may be similar to the layout shown with respect to FIG. 31.

A 3D digital holographic based method has been desired by the Defense Advanced Research Projects Agency (DARPA) of the Department of Defense, identified by Notice ID No. DARPA-PS-24-06. Corresponding documents, entitled “Additive Manufacturing of Microsystems (AMME)”, were published online on May 9, 2024, and the entire contents of which are hereby incorporated by reference in their entirety. (https://sam.gov/opp/42881234bf59467e9c8a5ea5bda12e27/view). In an embodiment, the 3D holographic patterning process may be incorporated into the present disclosure for adaptive AM implementation and the arrangements and configurations described. In an embodiment, the above-described 2.5D process, shown in FIG. 12B, is a simplified and more efficient process over the method proposed by DARPA, which utilizes 3D holograms to build a 3D circuit.

The process 1300 then proceeds to block 1316 where adhesive material is dispensed to allow the placement of either chips/circuitry in block 1318 or other components in block 1320, such as by using a pick and place process. After dispensing of the adhesive or placement of the chip/components, a curing process may be performed in block 1322. In some embodiments, additional material may be deposited in block 1324 for underfill or to encapsulate components prior to curing in block 1322.

The process 1300 then proceeds to block 1326 where an inspection is performed prior to any final fabrication processes or post fabrication inspection. It should be appreciated that the process 1300 provides for flexibility in the configuration of the fabrication process to accommodate the target object(s) being fabricated. In one or more embodiments, the process 1300 may loop back to block 1304 for additional fabrication of additional package substrates.

Referring to FIGS. 12A-12B, after the curing process the manufactured object may be passed back for further VAM or move forward to conductive/adhesive dispense processes to create a N+1 layer for iterative fabrication of a three-dimensional structure. In some embodiments, after the inspection process the manufacture object may bypass the high-resolution 3D print processes and dispenser-based 3D print processes and proceed to conductive/adhesive dispense processes.

After the conductive/adhesive dispense processes, the manufactured object may undergo chiplet die P&P and/or component P&P followed up by epoxy underfill/encapsulation processes and a curing process. In some embodiments, pick and place operations may begin directly from substrate inspection process and fabrication of circuit networks from the methods described occurs following chip die and/or component placement on substrate. In other embodiments the fabrication of circuit networks from the methods described occurs first, then chip die and/or component placements are performed. In this manner, multiple chip package structures may be fabricated. In some embodiments, After the conductive/adhesive dispense and/or print/patterning processes, the manufactured object may proceed to the curing process. After the curing process, the manufactured object undergoes a further inspection process, whereby the manufacture object will either be returned for further substrate fabrication or will proceed to final package processing and post-fabrication inspection. Once the manufacturing process is complete the manufactures object is removed from the build platform and the build platform can be reused for further AME applications.

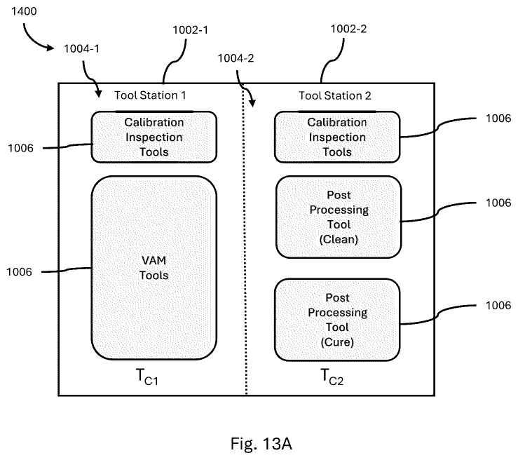

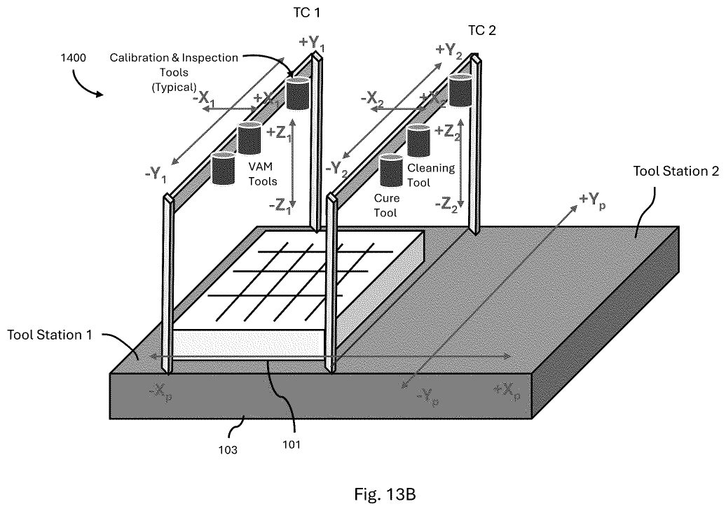

Referring now to FIGS. 13A-13B, shown is a schematic and a perspective view of an example 2×1 VAM Substrate-Only application 1400, i.e., High-Throughput Substrate Fabrication. The VAM Substrate-Only application, is a truncated version of the AM system for AME applications illustrated in FIGS. 10A-10B including tool station 1 1002-1 and tool station 2 1002-2, and like parts are numbered throughout. The build platform 101 may be a mobile build platform, multi-dimensional build platform, a dynamic substrate VAT, and combinations and variations thereof.

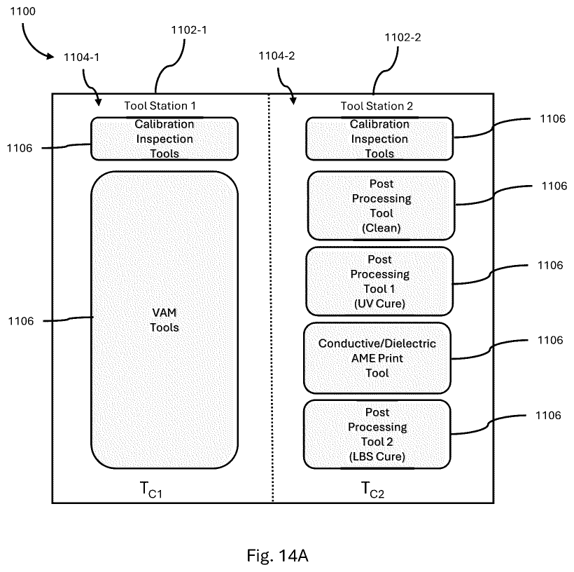

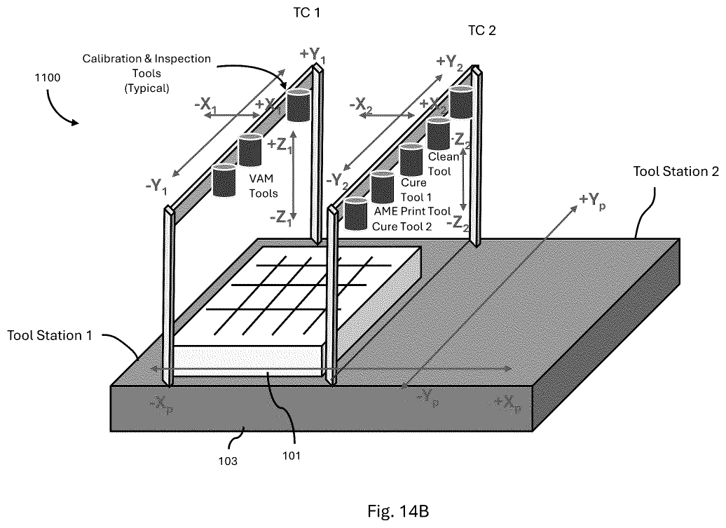

Referring now to FIGS. 14A-14B, shown is a schematic and a perspective view of an example minimal 2×1 platform for VAM-Based AME 1100, i.e., AME and Overprinting Applications/Connectors/Wire Harnesses. The minimal VAM-based AME application, is a truncated version of the AM system for semiconductor SiP/SoP chip package fabrication in FIGS. 11A-11B. Tool station 1 1102-1 may have tool cluster TC1 1104-1 mounted thereon and tool cluster TC1 may include VAM tools 1106 and calibration and inspection tools 1106. Tool station 2 1102-2 may have tool cluster TC2 1104-2 mounted thereon and tool cluster TC2 may include post processing tools 1106 for cleaning, post processing tools for UV curing, conductive/dielectric AME print tools, post processing curing tools (e.g., laser curing, light beam sintering), and calibration and inspection tools. At each manufacturing stage the build platform is moved under the respective tool station and the calibration and inspections tools will determine the relative position of the build platform 101. Then a respective manufacturing stage operation is performed by each of the respective tools at each tool station 1-2 1102. The build platform 101 may be a mobile build platform, multi-dimensional build platform, a dynamic substrate VAT, and combinations and variations thereof.

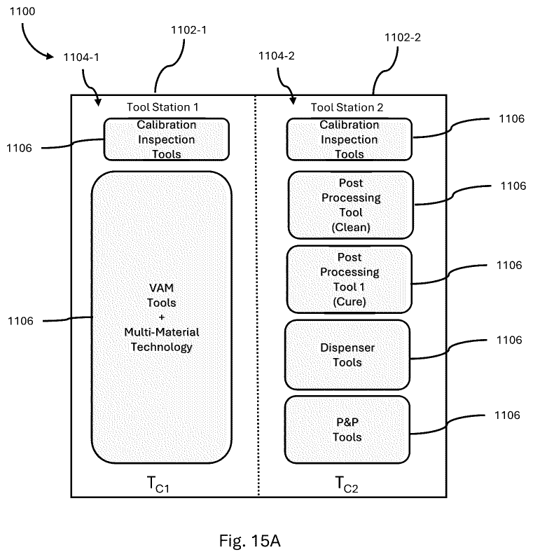

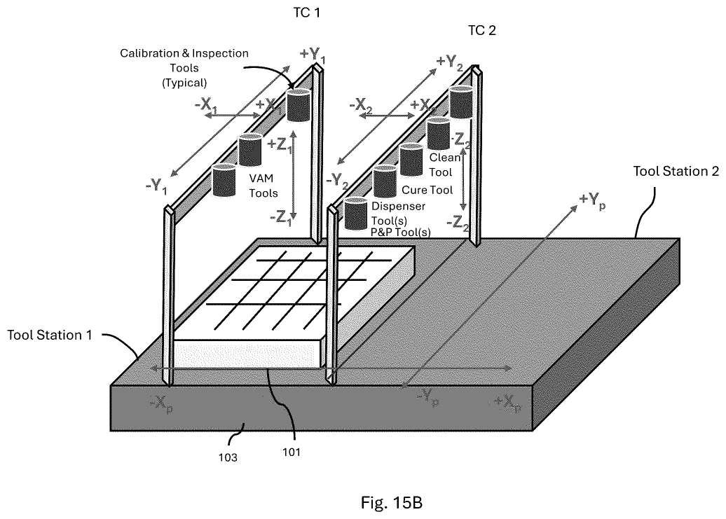

Referring now to FIGS. 15A-15B, shown is a schematic and a perspective view of an example optimized 2-Stage Pipeline for VAM-Based AME With Multi-Material Synthesis 1100, i.e., AME Applications, Overprinting Application, Semiconductor Packaging/HI. The minimal VAM-based AME application, is a truncated version of the AM system for semiconductor SiP/SoP chip package fabrication in FIGS. 11A-11B. Tool station 1 1102-1 may have tool cluster TC1 1104-1 mounted thereon and tool cluster TC1 may include VAM tools 1106 (that supports multiple material types and processing) and calibration and inspection tools 1106. Tool station 2 1102-2 may have tool cluster TC2 1104-2 mounted thereon and tool cluster TC2 may include post processing tools 1106 for cleaning, post processing tools for curing, dispenser tools, P&P tools, and calibration and inspection tools. At each manufacturing stage the build platform is moved under the respective tool station and the calibration and inspections tools will determine the relative position of the build platform 101. Then a respective manufacturing stage operation is performed by each of the respective tools at each tool station 1-2 1102. The build platform 101 may be a mobile build platform, multi-dimensional build platform, a dynamic substrate VAT and combinations and variations thereof.

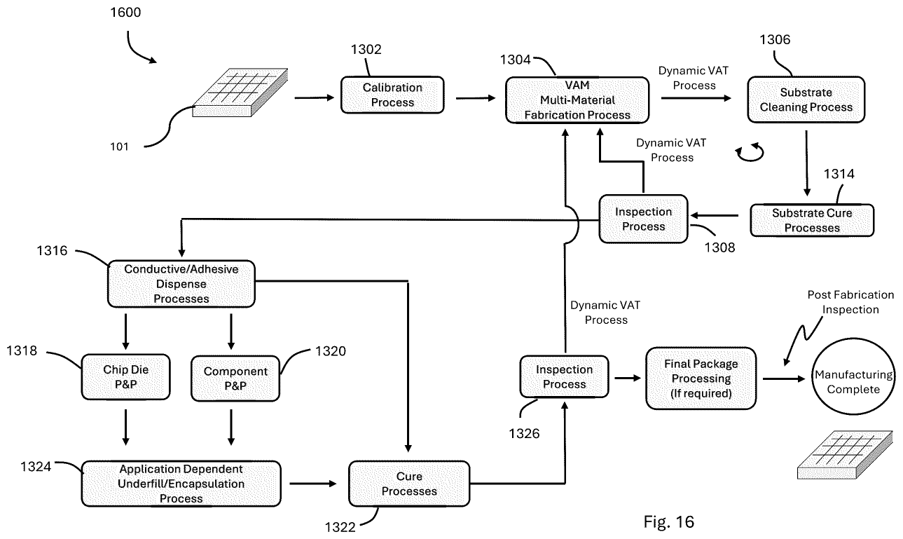

Referring now to FIG. 16, shown is a flow chart showing a process 1600 for optimized 2×1 Platform for VAM-Based AME With Multi-Material Synthesis. The method for optimized 2×1 Platform for VAM-Based AME With Multi-Material Synthesis may be the same or substantially the same as the process illustrated in FIGS. 12A and 12B, excluding the 3D print processes and dispenser-based 3D print processes which in the case of multi-material synthesis would be integrally incorporated within a single VAM process or tool station functionality. Like blocks are marked throughout the process 1600 that relate to process 1300. The build platform 101 may be a mobile build platform, multi-dimensional build platform, a dynamic substrate VAT, and combinations and variations thereof.

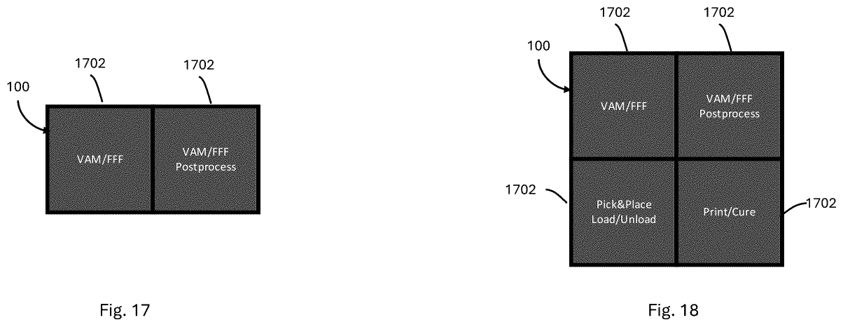

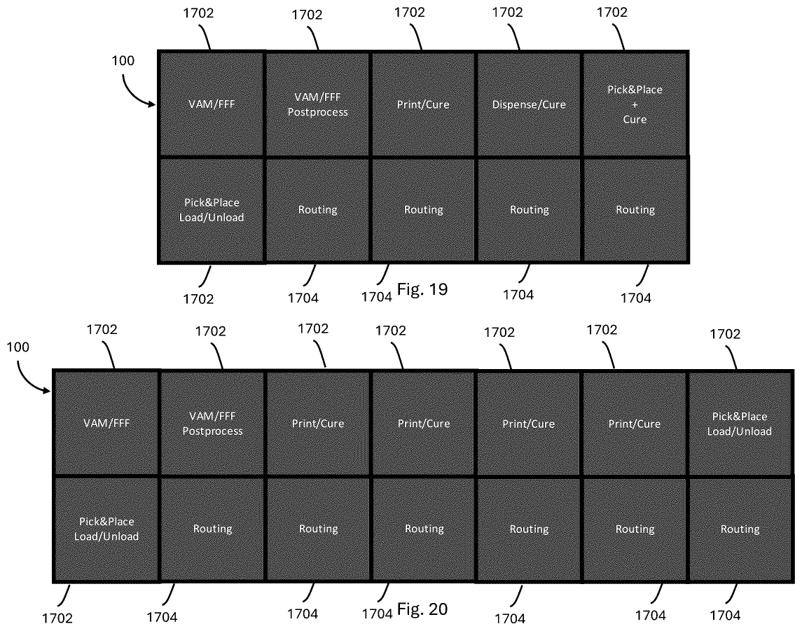

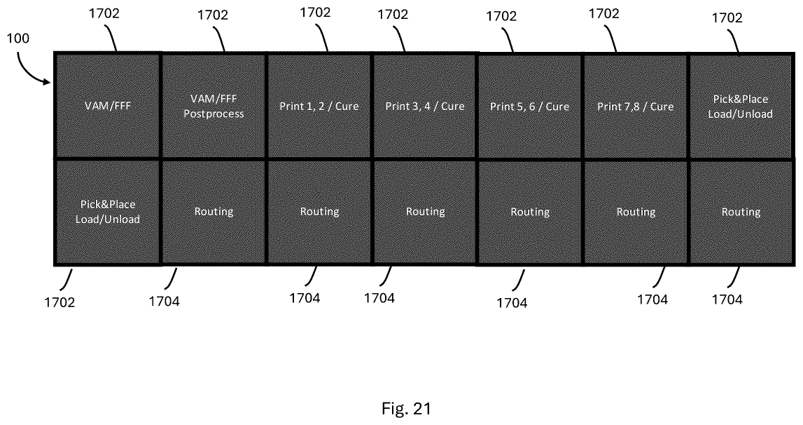

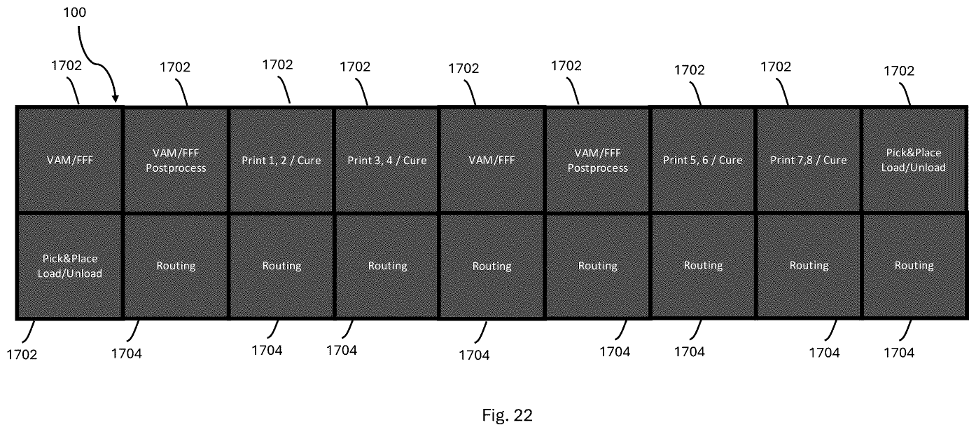

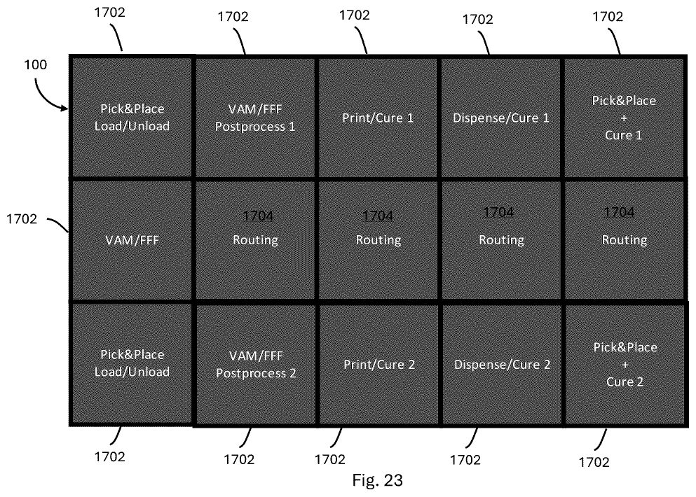

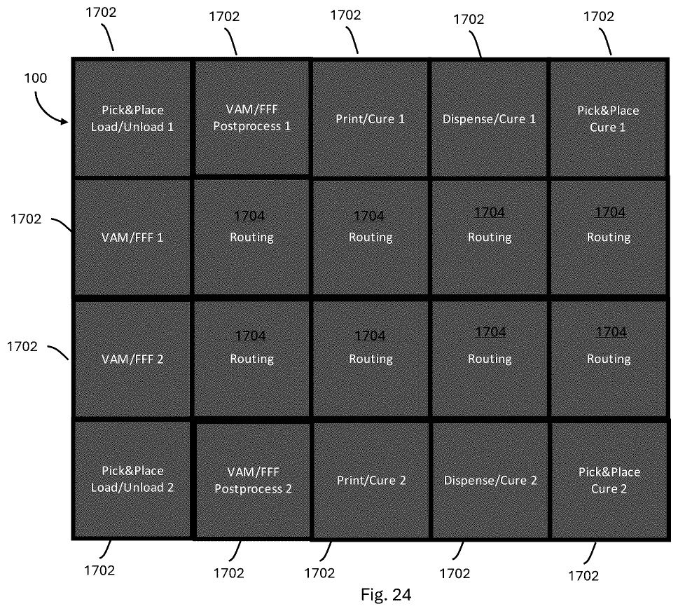

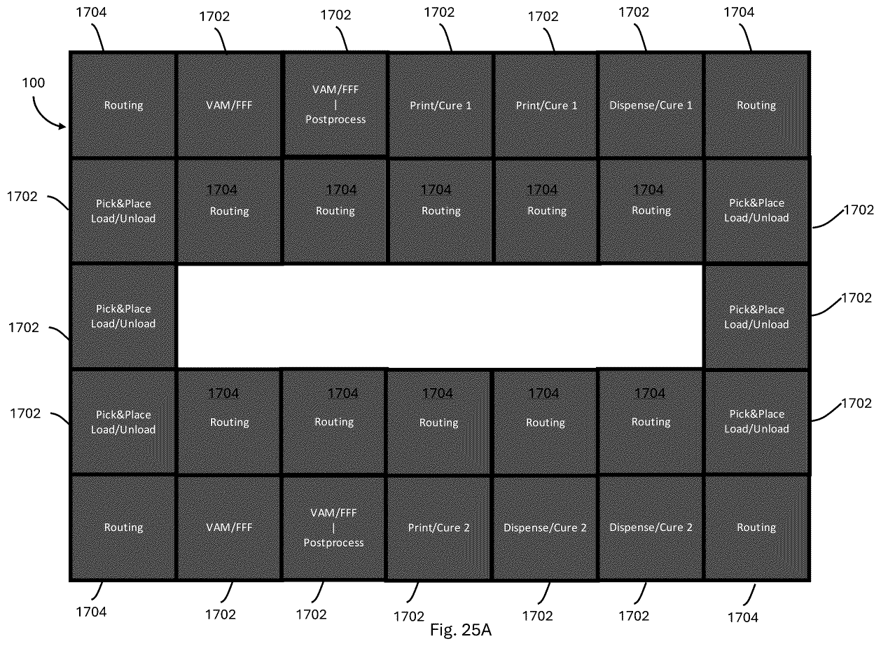

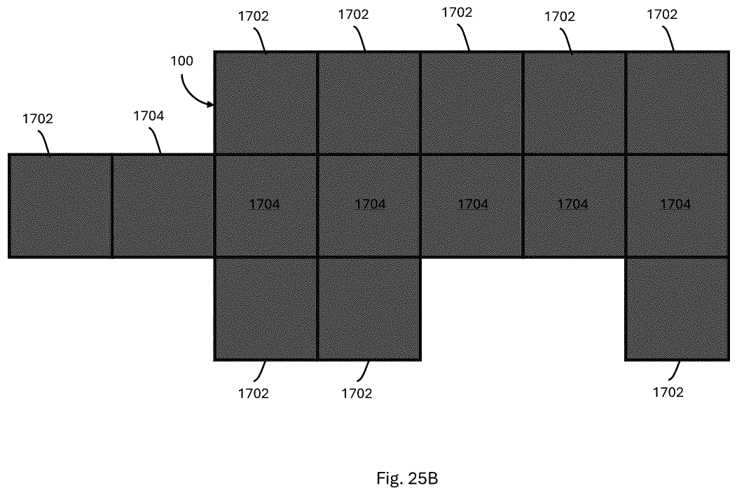

Referring now to FIGS. 17-25C, shown are various schematic layouts for adaptive additive manufacturing systems 100 according to some embodiments of the present disclosure. As illustrated in FIGS. 17-25C the adaptive additive manufacturing system 100 comprises one or more arrangements of various cells or blocks. It should be understood that the arrangement of various cells or blocks may be linear, semi-linear, non-linear, or combinations thereof. Any configuration of cells or blocks is anticipated. In non-limiting examples, FIGS. 17-24 depict cells or blocks in a matrix-like arrangement and FIGS. 25A-25C depict cells or blocks in a semi-linear and non-linear arrangement. The individual cells or blocks may relate to one or more tool stations, as described herein (such as with respect to tool station 105, 503), one or more tool clusters (such as with respect to tool cluster 109), and/or one or more tools (such as with respect to tools 107). The cells or blocks 1702 may include loading/unloading cells, various additive manufacturing system tools, volumetric additive manufacturing tools and systems, direct light processing engine or calibration tools, direct write jetting, inkjet, EHD tools, extruders, dispensing, and aerosol-based printing tools, post processing cells (for cleaning, curing, sintering, inspection/testing), robots, and routing cells 1704, as described herein (such as routing cell 1201), although not limited thereto. In this way the cells can be arranged in any configuration for a given additive manufacturing application. In some instances, one or more cells or blocks of a given layout may include the same or similar tool, process, or system. For example, FIG. 19 depicts several routing cells adjacent to each other and FIG. 20 depicts several print/cure blocks adjacent to each other. Some exemplary layouts are illustrated in FIGS. 17-25C. It should also be understood that although cells or blocks 1702, 1704 are labeled (or identified with explanations) as one configuration, that any configuration is appreciated, including rearranging the cells or blocks 1702, 1704 as needed to achieve a desired arrangement.

In some embodiments, the same or similar tool, process or system elements may be grouped together into a single or set of resource groups, where build platforms may be directed based on load, availability, or performance objectives. For example, if one tool station is occupied or otherwise unavailable, a build platform may be assigned to a free or available one. In this manner the throughput of the overall manufacturing process is increased.

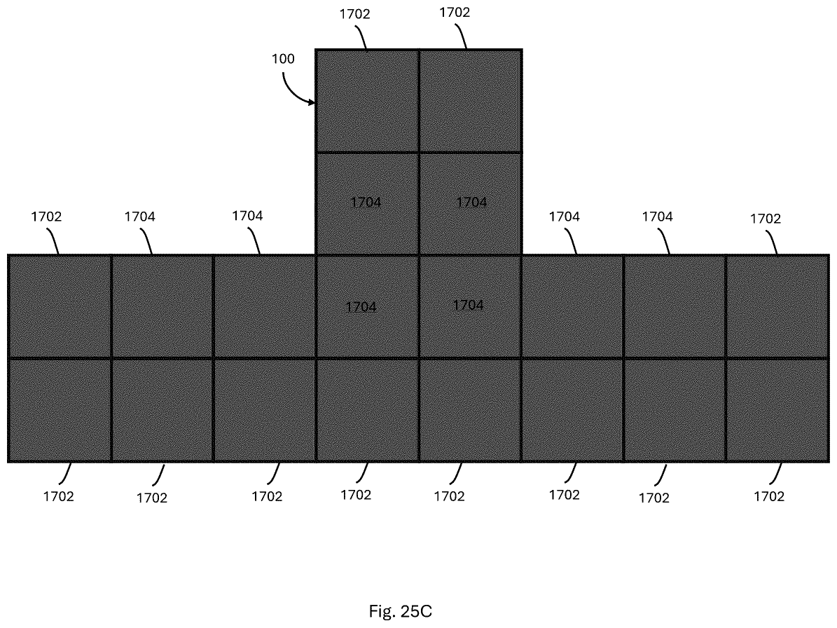

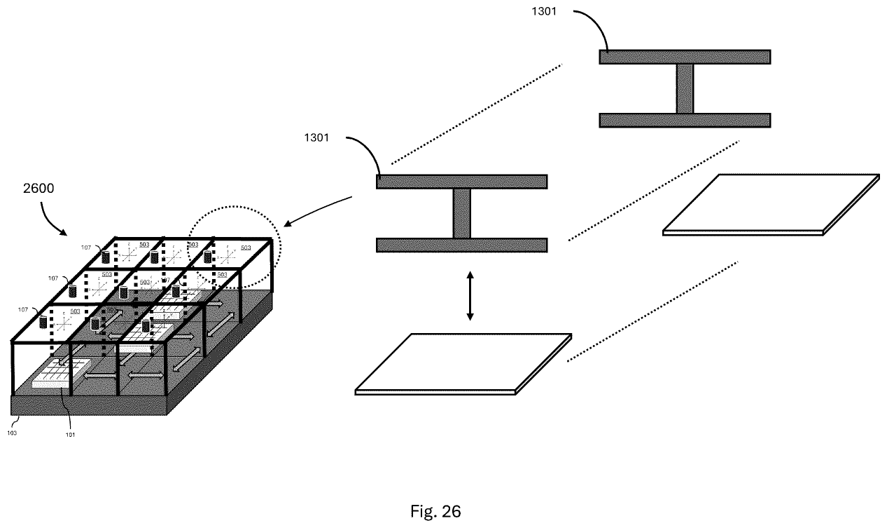

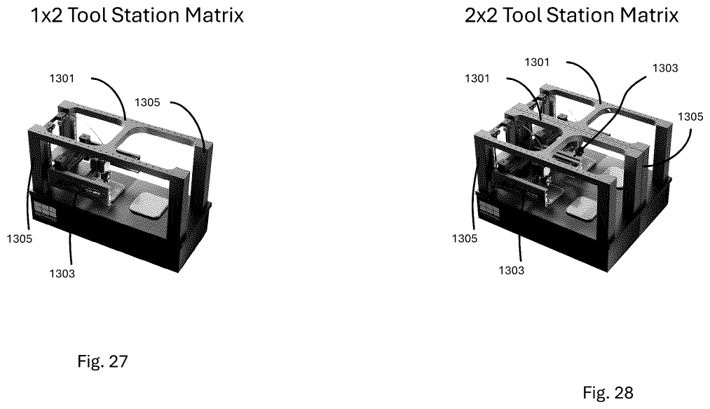

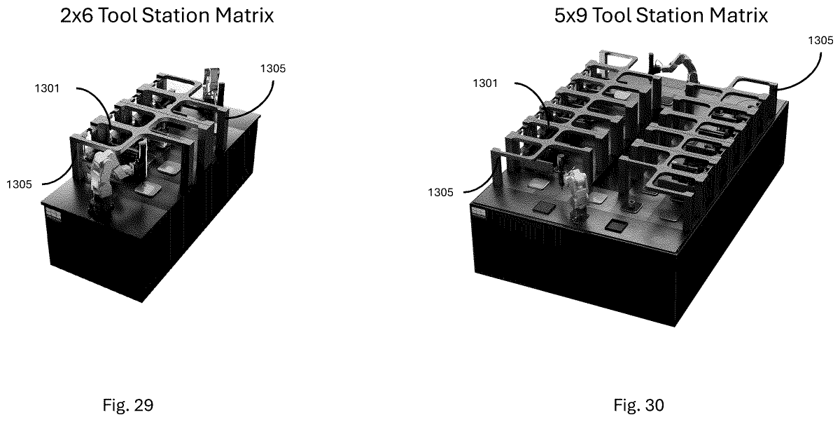

Referring now to FIGS. 26-31, shown is a perspective view of adaptive additive manufacturing systems 2600 according to some embodiments of the present disclosure. In some embodiments, the adaptive additive manufacturing system may include a truss 1301 (depicted as an “H” shape in the figures) forming a tool station that includes a gantry 1303 for multiple motion axes of tools mounted within the truss. The gantry may include various shapes and sizes depending on a desired operation/arrangement. In some instances, the gantry may be flexible. In some instances, the truss 1301 may be modular/configurable such that the gantry 1303 may be inserted, removed, and/or adjusted relative to the truss 1301. One or more gantries 1303 may be coupled to each other and positioned relative to one or more trusses 1301. Thus, in a non-limiting example, the gantry 1303 may be inserted, removed, and/or adjusted relative to at least the truss 1301 without impacting other components.

The H-shaped truss may support the mounting of different tool types and motion platform arrangements through a simplified insertion or removal process. The H-shaped truss may be layered or stacked in X and Y directions relative to the build platform to form a plurality of highly modular arrangements to build any size platform. In some embodiments, the H-shaped truss will maintain a reduced or minimal deflection across the tool station when mounting tools or motion platforms. For example, the deflection across the tool station may be about 1 micron or less. In some instances, the H-shaped truss may be configured to route cables, hoses, and/or other connections within one or more channels of the H-shaped truss (not shown). The H-shaped truss may be configured to mount, either directly or indirectly, on Z-axis columns 1305 that are configurable in height. Thus, the overall X, Y, and Z build volume for each tool station is configurable. In an embodiment, the H-shaped truss coupled to the Z-axis columns 1305 may contain cables, hoses, tool station material supply and/or other connections within the H-shaped truss and Z-axis columns 1305.

It should be appreciated that while embodiments herein illustrate the truss 1301 as having an “H” shape (when viewed from above), this is for example purposes and the claims should not be so limited. In other embodiments, other truss shapes may be used. As discussed above, in some embodiments, the “H” shape of the truss provides advantages in reducing the amount deflection across the tool station.

One or more mobile build platforms move and are routed through the adaptive additive manufacturing system among the one or more tool stations. The gantries 1303 may support various tools as part of the additive manufacturing systems, or post processing tools as discussed herein. In some embodiments, adjacent “cells” of the truss system 1301 may be combined to support a larger gantry 1303 such that a larger build volume is implemented within the tool station. In an embodiment, a larger mobile build platform can be implemented and routed under the respective configured gantry for a given additive manufacturing application. In another embodiment, a larger build volume may be implemented through precise mobile build platform movements in the X-Y motion plane of the mobile build platform. In this way the same truss system 1301 may be used and configured to support various manufacturing applications of different sized parts, different build volumes, and different sized mobile build platforms, and combinations thereof. In an embodiment, the configuration and arrangement of tool stations their associated gantries, build volumes and different sized mobile build platforms can vary from tool station to tool station such that a plurality of configurations and arrangements of the additive manufacturing system are simultaneously supported.

Referring to FIG. 31, shown is the adaptive additive manufacturing system and accompanying schematic depicting one conceivable arrangement, although alternative arrangements are appreciated, according to embodiments of the present disclosure. A chip package CAD model is introduced into the 2.5D or 3D digital patterning process, as previously described. The process produces a code that is introduced to the unified platform transport protocol. In an embodiment, the process may be the same as that described in U.S. Provisional Application Ser. No. 63/845073 filed Jul. 16, 2025 entitled “System and Methods for AM Platform Tool Integration”, the contents of which is incorporated by reference herein.

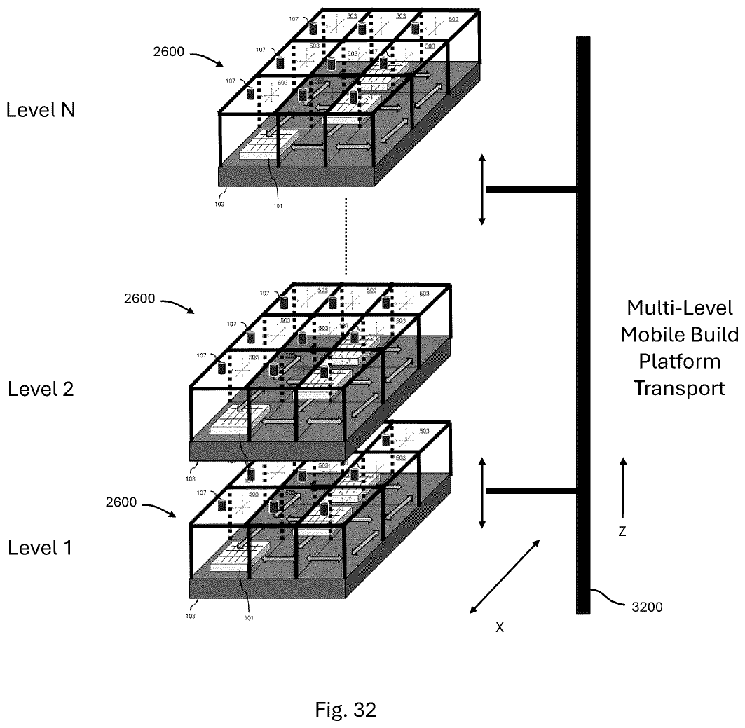

Referring now to FIG. 32, in some environments, such as, for example, space constrained environments, it may be desirable to stack multiple platforms vertically (e.g., Z direction) or in combination of horizontally (e.g., X and Y direction) and vertically (e.g., Z direction) to minimize the footprint of the AM platform. In an embodiment, the modular nature of the tool stations and AM platform is stacked in the vertical or +Z direction in a manner similar to a multi-story building. In some embodiments, a multi-level mobile build platform transport mechanism 3200 is coupled to each layer in order to facilitate the movement of build platforms between any layer in the multi-level structure. The multi-level structure may include N levels stacked in the Z direction. In some embodiments, the transport mechanism 3200 is also movable in an X direction to access additional adaptive additive manufacturing systems 2600.

The following clauses further define particular aspects and embodiments of the present disclosure.
Clause 1. A system for additive manufacturing, the system including a build platform movably coupled to a motion platform, the build platform movable and/or rotatable relative to a tool station, the tool station suspended relative to the build platform, wherein the tool station includes one or more tools coupled thereto, the one or more tools being movable in at least one direction relative to the build platform, wherein the build platform is movable and/or rotatable under the tool station.
Clause 2. The system of clause 1, wherein the tool station is a plurality of tool stations, wherein each tool station of the plurality of tool stations includes one or more tools coupled thereto, wherein the build platform is movable relative to the motion platform under each tool station of the plurality of tool stations.
Clause 3. The system of any of the preceding clauses, wherein the build platform is a plurality of build platforms, wherein at least one build platform of the plurality of build platforms is movable and/or rotatable relative to the tool station.
Clause 4. The system of any of the preceding clauses, wherein the build platform is movable using magnetic levitation.
Clause 5. The system of any of the preceding clauses, wherein the one or more tools coupled to the tool station are mounted on a tool holder and the tool holder is mounted on the tool station.
Clause 6. The system of clause 5, further including one or more calibration tools mounted within the tool station.
Clause 7. The system of any of the preceding clauses, wherein the tool station further includes an automated tool holder, wherein the automated tool holder is selected from the group including magnetic, robotic, mechanical, and combinations thereof.
Clause 8. The system of clause 7, wherein the automated tool holder is a dual-sided tool exchanger.
Clause 9. The system of any of the preceding clauses, wherein the tool station includes an H-shaped truss.
Clause 10. The system of clause 9, wherein the tool station is a first tool station and the H-shaped truss is a first H-shaped truss, wherein the first H-shaped truss is configured to couple with a second adjacent H-shaped truss of a second adjacent tool station.
Clause 11. The system of any of the preceding clauses, wherein the one or more tools are movable in the X direction, the Y direction, and/or the Z direction.
Clause 12. The system of any of the preceding clauses, wherein the build platform is a first build platform, wherein the system includes a second build platform, wherein the first build platform and the second build platform are coupled to each other in at least one of the X direction, the Y direction, and/or the Z direction to form a build platform greater in size than the first build platform.
Clause 13. The system of any of the preceding clauses, wherein the tool station includes a truss and a gantry, wherein the gantry is movable relative to the truss.
Clause 14. The system of any of the preceding clauses, wherein the tool station defines a tool station environment within the tool station, wherein the tool station environment is similar to or different from an environment external to the tool station.
Clause 15. The system of clause 14, wherein the tool station environment is configured to control or produce a desired condition, wherein the desired condition includes one or more of controlling humidity, temperature, air quality, producing a clean room, and combinations thereof.
Clause 16. The system of any of the preceding clauses, wherein the build platform is selected from the group including a mobile build platform, a multi-dimensional build platform, a dynamic substrate VAT, and combinations thereof.
Clause 17. The system of any of the preceding clauses, wherein the build platform is configured to be added to or removed from the motion platform.
Clause 18. An assembly for additive manufacturing, the assembly including a first system according to any of the preceding clauses, and a second system according to any of the preceding clauses, wherein the first system is positioned relative to the second system in at least one direction.
Clause 19. A method of performing a digital patterning process to a manufactured object, the method including providing a layer of the manufactured object, exposing the layer of the manufactured object to a first wavelength and a second wavelength, and identifying a first portion of the layer as an insulating region using the first wavelength and a second portion of the layer as a conducting region using the second wavelength, wherein the first portion and the second portion are arranged in a desired pattern.
Clause 20. The method of clause 19, wherein the layer is a first layer, the method further including providing a second layer of the manufactured object over the first layer of the manufactured object, exposing the second layer of the manufactured object to the first wavelength and the second wavelength, and identifying a first portion of the second layer as an insulating region using the first wavelength and a second portion of the second layer as a conducting region using the second wavelength, wherein the first portion and the second portion are arranged in a desired pattern.
Clause 21. The method of any of clauses 19-20, wherein the first layer is formed using a 2D dataset and a multi-level structure is formed by a plurality of 2D datasets.
Clause 22. The method of clause 21, wherein the 2D dataset includes metadata configured to instruct at least a portion of the digital patterning process.
Clause 23. The system of any of the preceding clauses further comprising one or more tools configured to remain stationary relative to the build platform.
Clause 24. A system for additive manufacturing, the system including a build platform movably coupled to a motion platform, the build platform movable and/or rotatable relative to a tool station, the tool station suspended relative to the build platform, wherein the tool station includes one or more tools coupled thereto, the one or more tools being positioned relative to the build platform, wherein the build platform is movable and/or rotatable under the tool station and/or the one or more tools are movable relative to the build platform.
Clause 25. A system for additive manufacturing, the system including a plurality of build platforms, at least one build platform of the plurality of build platforms is movably coupled to a motion platform, at least one build platform of the plurality of build platforms is movable and/or rotatable relative to a tool station of a plurality of tool stations, the plurality of tool stations are suspended relative to the plurality of build platforms, wherein each tool station of the plurality of tool stations includes one or more tools coupled thereto, the one or more tools being positioned relative to the build platform, wherein at least one of the plurality of build platforms is movable and/or rotatable under at least one tool station of the plurality of tool stations and/or the one or more tools of at least one tool station of the plurality of tool stations are movable relative to the at least one build platform of the plurality of build platforms.

The letter designations for the X, Y, and Z axes are for illustration purposes only and are not intended to limit the present disclosure. The use of the X, Y, and Z to define the directional axes and the relative frame of reference associated with the coordinate axes may be interchanged without departing from teachings of the present disclosure.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

1. A system for additive manufacturing, the system comprising:
a build platform movably coupled to a motion platform, the build platform movable and/or rotatable relative to a tool station;
the tool station suspended relative to the build platform, wherein the tool station includes one or more tools coupled thereto, the one or more tools being movable in at least one direction relative to the build platform;
wherein the build platform is movable and/or rotatable under the tool station.

2. The system of claim 1, wherein the tool station is a plurality of tool stations, wherein each tool station of the plurality of tool stations includes one or more tools coupled thereto,
wherein the build platform is movable relative to each tool station of the plurality of tool stations.

3. The system of claim 1, wherein the build platform is a plurality of build platforms, wherein at least one build platform of the plurality of build platforms is movable and/or rotatable relative to the tool station.

4. The system of claim 1, wherein the build platform is movable using magnetic levitation.

5. The system of claim 1, wherein the one or more tools coupled to the tool station are mounted on a tool holder and the tool holder is mounted on the tool station.

6. The system of claim 5, further comprising one or more calibration tools mounted within the tool station.

7. The system of claim 1, wherein the tool station further comprises an automated tool holder, wherein the automated tool holder is selected from the group comprising magnetic, robotic, mechanical, and combinations thereof.

8. The system of claim 7, wherein the automated tool holder is a dual-sided tool exchanger.

9. The system of claim 1, wherein the tool station includes an H-shaped truss.

10. The system of claim 9, wherein the tool station is a first tool station and the H-shaped truss is a first H-shaped truss, wherein the first H-shaped truss is configured to couple with a second adjacent H-shaped truss of a second adjacent tool station.

11. The system of claim 1, wherein the one or more tools are movable in one or more of the X direction, the Y direction, the Z direction, or combinations thereof.

12. The system of claim 1, wherein the build platform is a first build platform, wherein the system comprises a second build platform, wherein the first build platform and the second build platform are coupled to each other in at least one of the X direction, the Y direction, and/or the Z direction to form a build platform greater in size than the first build platform.

13. The system of claim 1, wherein the tool station includes a truss and a gantry, wherein the gantry is movable relative to the truss.

14. The system of claim 1, wherein the tool station defines a tool station environment within the tool station, wherein the tool station environment is similar to or different from an environment external to the tool station.

15. The system of claim 14, wherein the tool station environment is configured to control or produce a desired condition, wherein the desired condition includes one or more of controlling humidity, temperature, air quality, producing a clean room, and combinations thereof.

16. The system of claim 1, wherein the build platform is selected from the group consisting of a mobile build platform, a multi-dimensional build platform, a dynamic substrate VAT, and combinations thereof.

17. The system of claim 1, wherein the build platform is configured to be added to or removed from the motion platform.

18. An assembly for additive manufacturing, the assembly comprising:
a first system according to claim 1, and
a second system according to claim 1,
wherein the first system is positioned relative to the second system in at least one direction.

19. A method of performing a digital patterning process to a manufactured object, the method comprising:
providing a layer of the manufactured object;
exposing the layer of the manufactured object to a first wavelength and a second wavelength; and
identifying a first portion of the layer as an insulating region using the first wavelength and a second portion of the layer as a conducting region using the second wavelength, wherein the first portion and the second portion are arranged in a desired pattern.

20. The method of claim 19, wherein the layer is a first layer, the method further comprising:
providing a second layer of the manufactured object in proximity to the first layer of the manufactured object;
exposing the second layer of the manufactured object to the first wavelength and the second wavelength; and
identifying a first portion of the second layer as an insulating region using the first wavelength and a second portion of the second layer as a conducting region using the second wavelength, wherein the first portion and the second portion are arranged in a desired pattern.

21. The method of claim 19, wherein the first layer is formed using a 2D dataset and a multi-level structure is formed by a plurality of 2D datasets.

22. The method of claim 21, wherein the 2D dataset includes metadata configured to instruct at least a portion of the digital patterning process.
